(19) United States
(12) Patent Application Publication
(10) Pub. No.: US 2024/0062605 A1
(43) Pub. Date: Feb. 22, 2024

(54) ENTRY MANAGEMENT SYSTEM, ACCESS CONTROL APPARATUS, ACCESS CONTROL METHOD, AND RECORDING MEDIUM

(71) Applicant: NEC Corporation, Minato-ku, Tokyo (JP)

(72) Inventor: Akihiro TAGUCHI, Tokyo (JP)

(73) Assignee: NEC Corporation, Minato-ku, Tokyo (JP)

(21) Appl. No.: 18/269,589

(22) PCT Filed: Dec. 28, 2020
(86) PCT No.: PCT/JP2020/049167

§ 371 Date: Jun. 26, 2023

(51) Int. Cl. G07C 9/37; G06F 21/60

(52) U.S. Cl. CPC G07C 9/37; G06F 21/606; G07C 2209/12

(57) ABSTRACT

An entry management system SYS includes: a user terminal 1 that is possessed by a user U and is capable of notifying information to the user; and an entry control apparatus 3. The entry control apparatus includes: an acquisition unit 311 configured to acquire biological information on the user; a determination unit 312 configured to determine, based on the biological information, whether or not to permit entry of the user into a management target area MTA; and a control unit 313 configured to output determination result information to the user terminal in a case where it is determined that entry of the user into the management target area is not permitted.

### TECHNICAL FIELD

The present disclosure relates to a technical field of an entry management system, an access control apparatus, an access control method, and a recording medium for managing entry of a user into a management target area.

### BACKGROUND ART

There has been known an entry management system for managing entry of a user into a management target area. For example, Patent Reference 1 describes a permission control system, as an example of the entry management system, that acquires biological information on a user, which is detected by a biological information measurement apparatus (for example, a wearable apparatus) worn by the user, and determines, based on the acquired biological information, whether or not to permit entry of the user into a management space such as a room provided with an automatic door, an entry gate, or a smart lock. For the biological information, the permission control system described in Patent Reference 1, in particular, acquires biological information (for example, a body temperature) based on which it can be determined that the user has a predetermined virus or disease. In such a case, in a case where the body temperature acquired as the biological information is equal to or more than a reference body temperature (for example, 39 degrees), the permission control system according to Patent Reference 1 deems that the user has the predetermined disease or the like, and determines not to permit entry of the user into the management space.

Besides, background art references related to the present disclosure include Patent References 2 to 6.

### CITATION LIST

### Patent References

Patent Reference 1
Japanese Patent No. 6727684
Patent Reference 2
Japanese Patent Laid-Open No. 2011-067371 A
Patent Reference 3
Japanese Patent Laid-Open No. 2013-128572 A
Patent Reference 4
Japanese Patent Laid-Open No. 2013-236812 A
Patent Reference 5
Japanese Patent Laid-Open No. 2018-000278 A
Patent Reference 6
Japanese Patent Laid-Open No. 2019-106567 A

### SUMMARY

### Problem to be Solved

In a case where entry of a user into a management target area is not permitted, it is desired, from a user-friendly perspective, to notify the user of determination result information related to the result of determination that entry into the management target area is not permitted.

Here, generally, an entry management system acquires a body temperature of a user in a case where the user approaches an entrance-exit of a management target area, and determines, based on the acquired body temperature, whether or not to permit entry of the user into the management target area, in many cases. Accordingly, the entry management system notifies determination result information to the user who is present near the entrance-exit of the management target area.

However, in the vicinity of the entrance-exit of the management target area, there may be not only one user who is not permitted to enter the management target area, but also another user who is different from the one user. Accordingly, if the entry management system carelessly notifies determination result information to the one user, the determination result information may be unintentionally notified to the other user. For example, in a case where the entry management system notifies the determination result information to the one user by displaying the determination result information on a display disposed at the entrance-exit of the management target area, the determination result information displayed on the display may be unintentionally seen also by the other user. As a result, a technical problem arises that there is a possibility that the personal information on the one user, which is the fact that entry into the management target area is rejected, is not sufficiently protected.

An example object of the present disclosure is to provide an entry management system, an entry management apparatus, an entry management method, and a recording medium that are able to solve the above-described technical problem. As an example, an example object of the present disclosure is to provide an entry management system, an access control apparatus, an access control method, and a recording medium that are able to notify determination result information related to a result of determination to one user without letting another user know the determination result information in a case where entry of the one user into a management target area is not permitted.

### Means for Solving the Problem

One aspect of an entry management system is an entry management system for managing entry of a user into a management target area, the entry management system includes: a user terminal that is possessed by the user and is capable of notifying information to the user; and an access control apparatus, wherein the access control apparatus includes an acquisition unit configured to acquire biological information on the user, a determination unit configured to determine, based on the biological information, whether or not to permit entry of the user into the management target area, and an output unit configured to, in a case where it is determined that entry of the user into the management target area is not permitted, output determination result information related to a result of determination to the user terminal, and the user terminal includes a notification unit configured to notify the received determination result information to the user.

One aspect of an access control apparatus is an access control apparatus for managing entry of a user into a management target area, includes: an acquisition unit configured to acquire biological information on the user; a determination unit configured to determine, based on the biological information, whether or not to permit entry of the user into the management target area; and an output unit configured to, in a case where it is determined that entry of the user into the management target area is not permitted, output determination result information related to a result of determination to a user terminal that is possessed by the user and is capable of notifying information to the user.

One aspect of an entry management method is an access control method for managing entry of a user into a management target area, includes: acquiring biological information on the user; determining, based on the biological information, whether or not to permit entry of the user into the management target area; and outputting, in a case where it is determined that entry of the user into the management target area is not permitted, determination result information related to a result of determination to a user terminal that is possessed by the user and is capable of notifying information to the user.

One aspect of a recording medium is a recording medium storing a computer program, the computer program controlling a computer in such a manner that the computer executes a control access method for managing entry of a user into a management target area, the access control method including: acquiring biological information on the user; determining, based on the biological information, whether or not to permit entry of the user into the management target area; and outputting, in a case where it is determined that entry of the user into the management target area is not permitted, determination result information related to a result of determination to a user terminal that is possessed by the user and is capable of notifying information to the user.

### BRIEF DESCRIPTION OF THE DRAWINGS

FIG. 1 is a block diagram showing an entire configuration of an entry management system according to an example embodiment.

FIG. 2 is a schematic diagram showing a management target area in the present example embodiment.

FIG. 3 is a block diagram showing a configuration of a hearable terminal in the present example embodiment.

FIG. 4 is a block diagram showing a configuration of an entry management server in the present example embodiment.

FIG. 5 is a block diagram showing a configuration of an access control apparatus in the present example embodiment.

FIG. 6 is a flowchart showing a flow of operation performed by the hearable terminal in the present example embodiment.

FIG. 7 is a flowchart showing a flow of operation performed by the entry management server in the present example embodiment.

FIG. 8 is a flowchart showing a flow of operation performed by the access control apparatus in the present example embodiment.

FIG. 9 is a block diagram showing an entire configuration of an entry management system according to a first modification.

FIG. 10 is a block diagram showing a configuration of an access control apparatus 3 in the first modification.

FIG. 11 is a block diagram showing a configuration of an access control apparatus in a second modification.

FIG. 12 is a flowchart showing a flow of operation performed by the hearable terminal in the second modification.

FIG. 13 is a flowchart showing a flow of operation performed by the access control apparatus in the second modification.

FIG. 14 is a block diagram showing a configuration of an access control apparatus in a fourth modification.

FIG. 15 is a flowchart showing a flow of operation performed by the hearable terminal in the fourth modification.

FIG. 16 is a flowchart showing a flow of operation performed by the access control apparatus in the fourth modification.

### DESCRIPTION OF EXAMPLE EMBODIMENTS

Hereinafter, an example embodiment of an entry management system, an access control apparatus, an access control method, and a recording medium is described with reference to the drawings. In the following, an entry management system SYS is described to which the example embodiment of the entry management system, the access control apparatus, the access control method, and the recording medium is applied.

### (1) Outline of Entry Management System SYS

The entry management system SYS is a system capable of managing entry of a user U (see FIG. 2) into a management target area MTA (see FIG. 2). Specifically, the entry management system SYS is a system capable of acquiring biological information on the user U who is about to enter the management target area MTA and, based on the acquired biological information, determining whether or not to permit entry of the user U into the management target area MTA.

For example, the management target area MTA may be an area into which entry is permitted for a user U who satisfies a predetermined entry condition, whereas entry is restrained for a user U who does not satisfy the predetermined entry condition. An example of such a management target area MTA is specific premises (for example, an area that a user U cannot enter (that is, go into) unless the user U passes through an entrance of the premises). Examples of the premises include at least one of condominium premises, hotel premises, office building premises, school premises, plant premises, laboratory premises, government agency premises, and embassy premises. In such a case, the entry management system SYS may manage entry of a user U into the specific premises. Another example of the management target area MTA is the interior area of a specific building (for example, an area that a user U cannot enter (that is, go into) unless the user U passes through an entrance-exit of the building). Examples of the building include at least one of a condominium, a hotel, an office building, a school building, a plant building, a laboratory building, a government agency building, an embassy building, and the like. In such a case, the entry management system SYS may manage entry of a user U into the specific building. Another example of the management target area MTA is a specific room in a building (for example, an area that a user U cannot enter (that is, go into) unless the user U passes through an entrance of the room). Examples of the room include at least one of an apartment in a condominium, a guest room in a hotel, a floor of an office building, a classroom in a school, an office room in a plant, a research room in a laboratory, an office room in a government agency, an office room in an embassy, and the like. In such a case, the entry management system SYS may manage entry of a user U into the specific room. Another example of the management target area MTA is a specific zone demarcated by a structure such as a door in a building (for example, a zone that a user U cannot enter (that is, go into) unless the user U passes through the door or the like). In such a case, the entry management system SYS may manage entry of a user U into the specific zone in the building. Another example of the management target area MTA is an area outdoors demarcated by a structure such as a fence (for example, a venue for an event held outdoors). In such a case, the entry management system SYS may manage entry of a user U into the specific area outdoors.

As described above, the entry management system SYS can determine, based on the biological information, whether or not to permit entry of the user U into the management target area MTA. Accordingly, the above-mentioned entry condition, which indicates a condition for a user U to be permitted to enter the management target area MTA, may include an entry condition related to the biological information. In the following description, the entry condition related to the biological information is referred to as “biological condition.” For example, the biological condition may include a condition that “the biological information indicates that there is no possibility that the user U has a disease.” In such a case, the entry management system SYS may determine, based on the biological information, whether or not the biological information indicates that there is a possibility that the user U has a disease. In a case where the biological information indicates that there is no possibility that the user U has a disease, the entry management system SYS may determine to permit entry of the user U into the management target area MTA. In a case where the biological information indicates that there is a possibility that the user U has a disease, the entry management system SYS may determine not to permit entry of the user U into the management target area MTA. In other words, in a case where the biological information indicates that there is a possibility that the user U has a disease, the entry management system SYS may determine to restrain (in other words, prohibit) entry of the user U into the management target area MTA.

In the present example embodiment, an example is described in which body temperature information related to a body temperature (for example, a body surface temperature) of the user U is used for the biological information. In such a case, the above-mentioned entry condition, which indicates a condition for a user U to be permitted to enter the management target area MTA, may include an entry condition related to the body temperature. In such a case, the entry management system SYS may determine, based on the body temperature information, whether or not the body temperature information indicates that there is a possibility that the user U has a disease. In a case where the body temperature information indicates that there is no possibility that the user U has a disease, the entry management system SYS may determine to permit entry of the user U into the management target area MTA. In a case where the body temperature information indicates that there is a possibility that the user U has a disease, the entry management system SYS may determine not to permit entry of the user U into the management target area MTA. In other words, in a case where the body temperature information indicates that there is a possibility that the user U has a disease, the entry management system SYS may determine to restrain (in other words, prohibit) entry of the user U into the management target area MTA.

Hereinafter, details of a configuration and operation of the entry management system SYS that performs such entry management operation are described sequentially.

### (2) Configuration of Entry Management System SYS

First, the configuration of the entry management system SYS according to the present example embodiment is described.

### (2-1) Entire Configuration of Entry Management System SYS

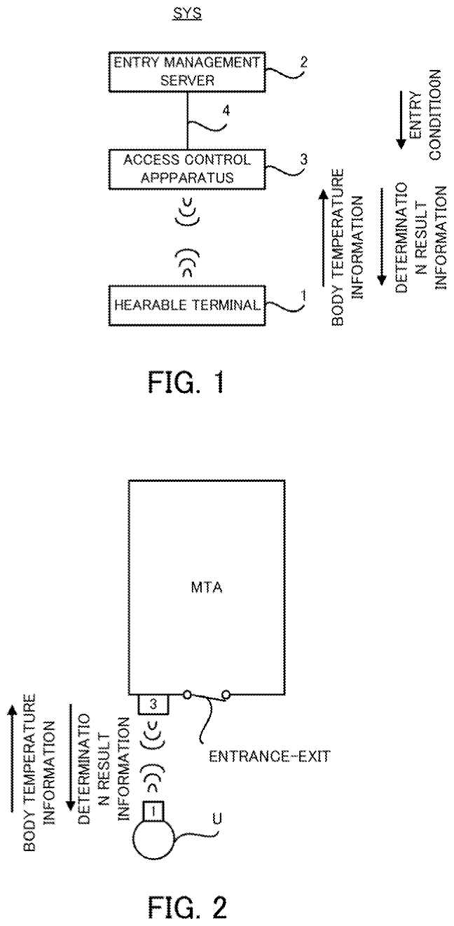

First, the entire configuration of the entry management system SYS according to the present example embodiment is described with reference to FIG. 1. FIG. 1 is a block diagram showing the entire configuration of the entry management system SYS according to the present example embodiment.

As shown in FIG. 1, the entry management system SYS includes a hearable terminal 1, which is one specific example of “user terminal,” an entry management server 2, and an access control apparatus 3. The entry management system SYS may include a single hearable terminal 1, or may include a plurality of hearable terminals 1. The entry management system SYS may include a single access control apparatus 3, or may include a plurality of access control apparatuses 3.

The hearable terminal 1 is a terminal apparatus (in other words, an information processing apparatus) possessed by a user U. The hearable terminal 1 is an apparatus that is wearable by the user U. The hearable terminal 1 is an apparatus particularly wearable in or over an ear of the user U. For example, the hearable terminal 1 may be an apparatus including an earphone (or headphones) wearable in or over an ear of the user U. Accordingly, the hearable terminal 1 may also be referred to as wearable terminal.

The hearable terminal 1 is an apparatus capable of outputting voice. In a case where the hearable terminal 1 outputs voice in a state where the hearable terminal 1 is worn in or over an ear of the user U, the voice outputted by the hearable terminal 1 is heard by the user U. On the other hand, it is preferable that the voice outputted by the hearable terminal 1 not be heard by a user U who does not wear the hearable terminal 1. Accordingly, the hearable terminal 1 may be an apparatus capable of outputting voice that the user U wearing the hearable terminal 1 can hear, whereas a user U who does not wear the hearable terminal 1 cannot. The hearable terminal 1 may be an apparatus capable of outputting voice only to the user U wearing the hearable terminal 1.

The hearable terminal 1 is an apparatus capable of detecting (that is, measuring) a body temperature of the user U wearing the hearable terminal 1. The body temperature information related to the body temperature of the user U detected by the hearable terminal 1 (for example, information quantitatively indicating the body temperature detected by the hearable terminal 1) is used to determine whether or not to permit entry of the user U into the management target area MTA.

The entry management server 2 is an apparatus capable of setting the above-mentioned entry condition, which indicates a condition for a user U to be permitted to enter the management target area MTA. The entry management server 2 transmits (in other words, delivers) the set entry condition to the access control apparatus 3. Further, the entry management server 2 may store and manage history information related to an archival record of a result of determination as to whether or not to permit entry of a user U into the management target area MTA.

For the entry management server 2 to transmit the entry condition to the access control apparatus 3, the entry management server 2 is capable of communicating with the access control apparatus 3. For example, the entry management server 2 may be capable of communicating with the access control apparatus 3 through a communication network 4. The communication network 4 may include a wired communication network. The communication network 4 may include a wireless communication network.

The access control apparatus 3 is an apparatus capable of determining whether or not to permit entry of a user U into the management target area MTA, by using the entry condition transmitted from the entry management server 2. As described above, the access control apparatus 3 is an apparatus capable of determining whether or not to permit entry of the user U into the management target area MTA, particularly based on the body temperature information. Accordingly, the access control apparatus 3 receives (that is, acquires) the body temperature information from the hearable terminal 1. The hearable terminal 1 transmits the body temperature information to the access control apparatus 3.

The hearable terminal 1 transmits the body temperature information to the access control apparatus 3. Accordingly, the hearable terminal 1 is capable of communicating with the access control apparatus 3. It is preferable that the hearable terminal 1 be capable of communicating with the access control apparatus 3, typically, through a wireless communication network. However, the hearable terminal 1 may be cable of communicating with the access control apparatus 3 through a communication network including a wired communication network.

The access control apparatus 3 notifies the user U of determination result information related to a result of determination as to whether or not to permit entry of the user U into the management target area MTA. For example, in a case where the access control apparatus 3 determines to permit entry of the user U into the management target area MTA, the access control apparatus 3 may notify the user U of the determination result information related to the result of determination that entry of the user U into the management target area MTA is permitted. For example, in a case where the access control apparatus 3 determines not to permit entry of the user U into the management target area MTA, the access control apparatus 3 may notify the user U of the determination result information related to the result of determination that entry of the user U into the management target area MTA is not permitted.

The access control apparatus 3 notifies the determination result information to the user U, by using the hearable terminal 1 worn by the user U. Accordingly, the operation performed by the access control apparatus 3 to notify the determination result information to the user U is an operation of outputting the determination result information to the hearable terminal 1. In such a case, the hearable terminal 1 worn by the user U notifies the user U of the determination result information that is outputted by the access control apparatus 3 and received by the hearable terminal 1. In other words, the access control apparatus 3 indirectly notifies the determination result information to the user U by using the hearable terminal 1, instead of directly notifying the determination result information to the user U. As described above, the hearable terminal 1 is capable of outputting voice. Accordingly, the hearable terminal 1 notifies the determination result information to the user U by using voice.

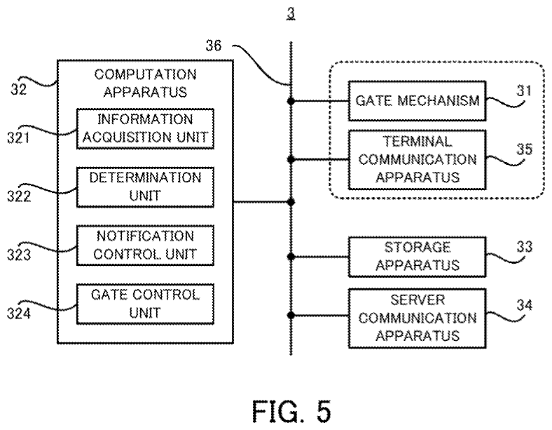

As shown in FIG. 2, the access control apparatus 3 may include an apparatus (for example, a gate mechanism 31, which will be described later with reference to FIG. 5) disposed in the management target area MTA, or near the management target area MTA. For example, in a case where an entrance-exit through which a user U can enter the management target area MTA is provided, the access control apparatus 3 may include the apparatus disposed at the entrance-exit of the management target area MTA.

The access control apparatus 3 may include an apparatus (for example, the gate mechanism 31, which will be described later with reference to FIG. 5) capable of restraining entry of a user U into the management target area MTA. The apparatus capable of restraining entry of a user U into the management target area MTA may be disposed in the management target area MTA, or near the management target area MTA. The apparatus capable of restraining entry of a user U into the management target area MTA may be disposed at the entrance-exit of the management target area MTA. For example, the access control apparatus 3 may be capable of restraining entry of a user U who is not permitted by the access control apparatus 3 to enter the management target area MTA. For example, in a case where the access control apparatus 3 includes a door (that is, one specific example of the gate mechanism 31), the access control apparatus 3 may be capable of restraining entry of the user U into the management target area MTA by keeping the door in a closed state. On the other hand, the access control apparatus 3 does not need to restrain entry of a user U who is permitted by the access control apparatus 3 to enter the management target area MTA. For example, in a case where the access control apparatus 3 includes the door, the access control apparatus 3 may permit entry of the user U into the management target area MTA by changing the state of the door from the closed state to an open state. Accordingly, the state of the access control apparatus 3 (in particular, the state of the apparatus capable of restraining entry of a user U into the management target area MTA) may be switched between a restraint state in which entry of a user U into the management target area MTA can be restrained, and a non-restraint state in which entry of a user U into the management target area MTA is not restrained. The access control apparatus 3 may switch the state of the apparatus capable of restraining entry of a user U into the management target area MTA between the restraint state and the non-restraint state, based on a result of determination as to whether or not to permit entry of a user U into the management target area MTA.

### (2-2) Configuration of Hearable Terminal 1

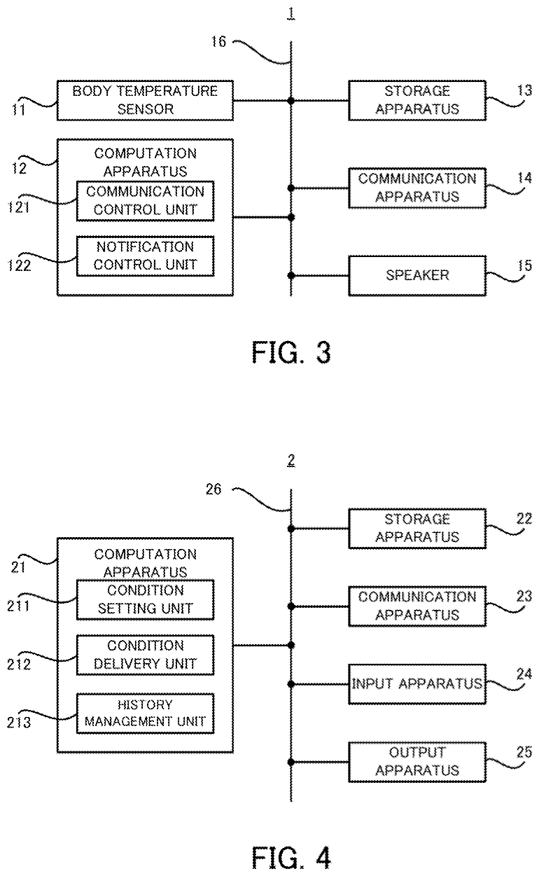

Next, a configuration of the hearable terminal 1 in the present example embodiment is described with reference to FIG. 3. FIG. 3 is a block diagram showing the configuration of the hearable terminal 1 in the present example embodiment.

As shown in FIG. 3, the hearable terminal 1 includes a body temperature sensor 11, a computation apparatus 12, a storage apparatus 13, a communication apparatus 14, and a speaker 15. The body temperature sensor 11, the computation apparatus 12, the storage apparatus 13, the communication apparatus 14, and the speaker 15 may be connected through a data bus 16.

The body temperature sensor 11 is a detection apparatus capable of detecting a body temperature of the user U wearing the hearable terminal 1. The body temperature sensor 11 may be a detection apparatus capable of detecting the body temperature of the user U by coming into contact with the user U (for example, a thermistor-based body temperature sensor). The body temperature sensor 11 may be a detection apparatus capable of detecting the body temperature of the user U without coming into contact with the user U (for example, an infrared body temperature sensor (for example, a body temperature sensor using a thermal camera or a thermographic camera)).

The computation apparatus 12 includes, for example, a CPU (Central Processing Unit). The computation apparatus 12 reads a computer program. For example, the computation apparatus 12 may read the computer program stored in the storage apparatus 13. For example, the computation apparatus 12 may read the computer program stored in a computer-readable non-transitory recording medium, by using an undepicted recording medium reading apparatus. The computation apparatus 12 may acquire (that is, may download or may read) the computer program from an undepicted apparatus disposed outside of the hearable terminal 1, via the communication apparatus 14 (or any other communication apparatus). The computation apparatus 12 executes the read computer program. As a result, a logical functional block for performing operation to be performed by the hearable terminal 1 (for example, operation of transmitting the body temperature information to the access control apparatus 3 and notifying the determination result information to the user U, as described above) is implemented in the computation apparatus 12. In other words, the computation apparatus 12 is capable of functioning as a controller for implementing the logical functional block for performing the operation to be performed by the hearable terminal 1.

FIG. 3 shows examples of the logical functional block implemented in the computation apparatus 12. As shown in FIG. 3, a communication control unit 121 and a notification control unit 122 are implemented in the computation apparatus 12. The communication control unit 121 transmits the body temperature information related to the body temperature of the user U detected by the body temperature sensor 11 to the access control apparatus 3 by using the communication apparatus 14. Moreover, the communication control unit 121 receives (that is, acquires) the determination result information related to a result of determination made by the access control apparatus 3 (that is, a result of determination as to whether or not to permit entry of the user U into the management target area MTA) from the access control apparatus 3 by using the communication apparatus 14. The notification control unit 122 controls the speaker 15 in such a manner that the determination result information received by the communication control unit 121 is notified to the user U.

The storage apparatus 13 is capable of storing desired data. For example, the storage apparatus 13 may temporarily store the computer program that is executed by the computation apparatus 12. The storage apparatus 13 may temporarily store data that is temporarily used by the computation apparatus 12 in a case where the computation apparatus 12 executes the computer program. The storage apparatus 13 may store data that is kept by the hearable terminal 1 on a long-term basis. Note that the storage apparatus 13 may include at least one of a random access memory (RAM), a read only memory (ROM), a hard disk apparatus, a magneto-optical disk apparatus, a solid state drive (SSD), and a disk array apparatus. In other words, the storage apparatus 13 may include a non-transitory recording medium.

The communication apparatus 14 is capable of communicating with the access control apparatus 3. The communication apparatus 14 is capable of communicating with the access control apparatus 3. The communication apparatus 14 is capable of communicating with the access control apparatus 3, typically, through a wireless communication network. However, the communication apparatus 14 may be capable of communicating with the access control apparatus 3 through a communication network including a wired communication network. Since the access control apparatus 3 is capable of communicating with the entry management server 2, the communication apparatus 14 may be capable of communicating with the entry management server 2 via the access control apparatus 3. In the present example embodiment, the communication apparatus 14 transmits the body temperature information to the access control apparatus 3, under control of the communication control unit 121. Moreover, the communication apparatus 14 receives (that is, acquires) the determination result information from the access control apparatus 3, under control of the communication control unit 121.

The speaker 15 is a voice output apparatus capable of outputting voice. In other words, the speaker 15 is a voice output apparatus capable of outputting information by using voice. In the present example embodiment, the speaker 15 outputs the determination result information by using voice, under control of the notification control unit 122. As a result, the user U wearing the hearable terminal 1 can aurally recognize the determination result information via the speaker 15 included as part in the earphone (or headphones) worn in or over an ear of the user.

### (2-3) Configuration of Entry Management Server 2

Next, a configuration of the entry management server 2 in the present example embodiment is described with reference to FIG. 4. FIG. 4 is a block diagram showing the configuration of the entry management server 2 in the present example embodiment.

As shown in FIG. 4, the entry management server 2 includes a computation apparatus 21, a storage apparatus 22, and a communication apparatus 23. Further, the entry management server 2 may include an input apparatus 24 and an output apparatus 25. However, the entry management server 2 may omit to include at least one of the input apparatus 24 and the output apparatus 25. The computation apparatus 21, the storage apparatus 22, the communication apparatus 23, the input apparatus 24, and the output apparatus 25 may be connected through a data bus 26.

The computation apparatus 21 includes, for example, a CPU. The computation apparatus 21 reads a computer program. For example, the computation apparatus 21 may read the computer program stored in the storage apparatus 22. For example, the computation apparatus 21 may read the computer program stored in a computer-readable non-transitory recording medium, by using an undepicted recording medium reading apparatus. The computation apparatus 21 may acquire (that is, may download or may read) the computer program from an undepicted apparatus disposed outside of the entry management server 2, via the communication apparatus 23 (or any other communication apparatus). The computation apparatus 21 executes the read computer program. As a result, a logical functional block for performing operation to be performed by the entry management server 2 (for example, operation of setting the entry condition, delivering the entry condition, and managing the history information, as described above) is implemented in the computation apparatus 21. In other words, the computation apparatus 21 is capable of functioning as a controller for implementing the logical functional block for performing the operation to be performed by the entry management server 2.

FIG. 4 shows examples of the logical functional block implemented in the computation apparatus 21. As shown in FIG. 4, a condition setting unit 211, a condition delivery unit 212, and a history management unit 213 are implemented in the computation apparatus 21. The condition setting unit 211 sets the entry condition. The condition delivery unit 212 transmits (delivers) the entry condition set by the condition setting unit 211 to the access control apparatus 3. The history management unit 213 stores and manages the history information related to an archival record of a result of determination as to whether or not to permit entry of a user U into the management target area MTA.

The storage apparatus 22 is capable of storing desired data. For example, the storage apparatus 22 may temporarily store the computer program that is executed by the computation apparatus 21. The storage apparatus 22 may temporarily store data that is temporarily used by the computation apparatus 21 in a case where the computation apparatus 21 executes the computer program. The storage apparatus 22 may store data that is kept by the entry management server 2 on a long-term basis. Note that the storage apparatus 22 may include at least one of a RAM, a ROM, a hard disk apparatus, a magneto-optical disk apparatus, an SSD, and a disk array apparatus. In other words, the storage apparatus 22 may include a non-transitory recording medium.

The communication apparatus 23 is capable of communicating with the access control apparatus 3 through the communication network 4 (see FIG. 1). Moreover, since the access control apparatus 3 is capable of communicating with the hearable terminal 1, the communication apparatus 23 may be capable of communicating with the hearable terminal 1 via the access control apparatus 3. In the present example embodiment, the information acquisition unit 321 communication apparatus 23 transmits the entry condition to the access control apparatus 3, under control of the condition delivery unit 212.

The input apparatus 24 is an apparatus that receives information as an input to the entry management server 2 from an outside of the entry management server 2. For example, the input apparatus 24 may include an operation apparatus (for example, at least one of a key board, a mouse, and a touch panel) that is operable by an operator of the entry management server 2. For example, the input apparatus 24 may include a reading apparatus capable of reading the information recorded as data in an external recording medium that is attachable to the entry management server 2.

The output apparatus 25 is an apparatus that outputs information to the outside of the entry management server 2. For example, the output apparatus 25 may output the information as an image. In other words, the output apparatus 25 may include a display apparatus (so-called display) capable of displaying an image indicating the information desired to be outputted. For example, the output apparatus 25 may output the information as voice. In other words, the output apparatus 25 may include an audio apparatus (so-called speaker) capable of outputting voice. For example, the output apparatus 25 may output the information on a sheet of paper. In other words, the output apparatus 25 may include a printing apparatus (so-called printer) capable of printing the desired information on a sheet of paper.

### (2-4) Configuration of Access Control Apparatus 3

Next, a configuration of the access control apparatus 3 in the present example embodiment is described with reference to FIG. 5. FIG. 5 is a block diagram showing the configuration of the access control apparatus 3 in the present example embodiment.

As shown in FIG. 5, the access control apparatus 3 includes the gate mechanism 31, a computation apparatus 32, a storage apparatus 33, a server communication apparatus 34, and a terminal communication apparatus 35. The gate mechanism 31, the computation apparatus 32, the storage apparatus 33, the server communication apparatus 34, and the terminal communication apparatus 35 may be connected through a data bus 36. Note that the server communication apparatus 34 and the terminal communication apparatus 35 may be integrated into one body as a single communication apparatus.

The gate mechanism 31 is an apparatus capable of restraining entry of a user U into the management target area MTA. For example, the gate mechanism 31 may be capable of restraining entry of a user U who is not permitted by the access control apparatus 3 to enter the management target area MTA. On the other hand, the access control apparatus 3 does not need to restrain entry of a user U who is permitted by the access control apparatus 3 to enter the management target area MTA.

An example of the gate mechanism 31 is an automatic door disposed at the entrance-exit of the management target area MTA. The automatic door may include, for example, a door that separates the management target area MTA from an area outside of the management target area MTA, a motor that moves the door in such a manner that the state of the door is switched between the open state and the closed state, and the like. In such a case, the access control apparatus 3 may be capable of restraining entry of a user U into the management target area MTA by keeping the door in the closed state. The access control apparatus 3 may permit entry of a user U into the management target area MTA by changing the state of the door from the closed state to the open state.

An example of the gate mechanism 31 is an automatic gate apparatus disposed at the entrance-exit of the management target area MTA. The automatic gate apparatus may include, for example, a blocking bar (for example, a member in a rod-like shape) capable of blocking a user's path between the management target area MTA and the area outside of the management target area MTA, a motor that moves the blocking bar in such a manner that the state of the blocking bar is switched between a blocking state, in which the blocking bar blocks a user's path, and an open state, in which the blocking bar does not block a user's path, and the like. In such a case, the access control apparatus 3 may be capable of restraining entry of a user U into the management target area MTA by keeping the blocking bar in the blocking state. The access control apparatus 3 may permit entry of a user U into the management target area MTA by changing the state of the blocking bar from the blocking state to the open state.

An example of the gate mechanism 31 is a door including a smart lock mechanism disposed at the entrance-exit of the management target area MTA. A smart lock is a lock capable of being unlocked based on an electronic control signal. In such a case, the access control apparatus 3 may be capable of restraining entry of a user U into the management target area MTA by keeping the smart lock in a locked state. The access control apparatus 3 may permit entry of a user U into the management target area MTA by changing the state of the smart lock from the locked state to an unlocked state.

The access control apparatus 3 may include a single gate mechanism 31. In other words, the access control apparatus 3 may control the state of the single gate mechanism 31. Alternatively, the access control apparatus 3 may include a plurality of gate mechanisms 31. In other words, the access control apparatus 3 may control the states of the plurality of gate mechanisms 31 in parallel.

The computation apparatus 32 includes, for example, a CPU. The computation apparatus 32 reads a computer program. For example, the computation apparatus 32 may read the computer program stored in the storage apparatus 33. For example, the computation apparatus 32 may read the computer program stored in a computer-readable non-transitory recording medium, by using an undepicted recording medium reading apparatus. The computation apparatus 32 may acquire (that is, may download or may read) the computer program from an undepicted apparatus disposed outside of the access control apparatus 3, via the server communication apparatus 34 (or any other communication apparatus). The computation apparatus 32 executes the read computer program. As a result, a logical functional block for performing operation to be performed by the access control apparatus 3 (for example, operation of receiving the body temperature information from the hearable terminal 1, determining, based on the body temperature information, whether or not to permit entry of the user U into the management target area MTA, and transmitting the determination result information to the hearable terminal 1, as described above) is implemented in the computation apparatus 32. In other words, the computation apparatus 32 is capable of functioning as a controller for implementing the logical functional block for performing the operation to be performed by the access control apparatus 3.

FIG. 5 shows examples of the logical functional block implemented in the computation apparatus 32. As shown in FIG. 5, an information acquisition unit 321, which is one specific example of “acquisition unit,” a determination unit 322, which is one specific example of “determination unit,” a notification control unit 323, which is one specific example of “output unit,” and a gate control unit 324 are implemented in the computation apparatus 32. The information acquisition unit 321 receives (that is, acquires) the body temperature information from the hearable terminal 1 by using the terminal communication apparatus 35. The determination unit 322 determines, based on the body temperature information received by the information acquisition unit 321, whether or not to permit entry of the user U into the management target area MTA. The notification control unit 323 transmits, to the hearable terminal 1 by using the terminal communication apparatus 35, the determination result information related to a result of determination made by the determination unit 322 (that is, a result of determination as to whether or not to permit entry of the user U into the management target area MTA). The gate control unit 324 controls the gate mechanism 31, based on the result of determination made by the determination unit 322. In other words, the gate control unit 324 switches the state of the gate mechanism 31 between the restraint state, in which the gate mechanism 31 restrains entry of a user U into the management target area MTA, and the non-restraint state, in which the gate mechanism 31 permits (that is, does not restrain) entry of a user U into the management target area MTA.

The storage apparatus 33 is capable of storing desired data. For example, the storage apparatus 33 may temporarily store the computer program that is executed by the computation apparatus 32. The storage apparatus 33 may temporarily store data that is temporarily used by the computation apparatus 32 in a case where the computation apparatus 32 executes the computer program. The storage apparatus 33 may store data that is kept by the access control apparatus 3 on a long-term basis. Note that the storage apparatus 33 may include at least one of a RAM, a ROM, a hard disk apparatus, a magneto-optical disk apparatus, an SSD, and a disk array apparatus. In other words, the storage apparatus 33 may include a non-transitory recording medium.

The server communication apparatus 34 is capable of communicating with the entry management server 2 through the communication network 4 (see FIG. 1). In the present example embodiment, the server communication apparatus 34 transmits, to the entry management server 2, the body temperature information transmitted by the hearable terminal 1, under control of the communication control unit 321. Moreover, the server communication apparatus 34 receives (that is, acquires), from the entry management server 2, the determination result information transmitted by the entry management server 2 toward the hearable terminal 1, under control of the communication control unit 321. The server communication apparatus 34 receives (that is, acquires) a gate control signal from the entry management server 2, under control of the communication control unit 321. The communication apparatus 23 receives (that is, acquires) the body temperature information from the hearable terminal 1 via the access control apparatus 3, under control of the information acquisition unit 321. The communication apparatus 23 transmits the determination result information to the hearable terminal 1 via the access control apparatus 3, under control of the notification control unit 323. The communication apparatus 23 transmits the gate control signal to the access control apparatus 3, under control of the gate control unit 214.

The terminal communication apparatus 35 is capable of communicating with the hearable terminal 1. In the present example embodiment, the terminal communication apparatus 35 receives (that is, acquires) the body temperature information transmitted by the hearable terminal 1, under control of the information acquisition unit 321. The terminal communication apparatus 35 transmits the determination result information to the hearable terminal 1, under control of the notification control unit 323.

The terminal communication apparatus 35 may be disposed together with the gate mechanism 31, in or near the gate mechanism 31. The terminal communication apparatus 35 may be disposed together with the gate mechanism 31, in or near the gate mechanism 31, typically, in such a manner that the terminal communication apparatus 35 and the gate mechanism 31 are associated one-to-one with each other. In such a case, the terminal communication apparatus 35 may receive the body temperature information from the user terminal 1 possessed by the user U who is about to enter the management target area MTA via the gate mechanism 31 associated with the terminal communication apparatus 35. The terminal communication apparatus 35 may transmit the determination result information related to a result of determination as to whether or not to permit entry of the user U into the management target area MTA, to the user terminal 1 possessed by the user U who is about to enter the management target area MTA via the gate mechanism 31 associated with the terminal communication apparatus 35.

The terminal communication apparatus 35 may transmit (in other words, output) the gate detection signal. The gate detection signal is, for example, a signal that can be received (in other words, can be detected) by the hearable terminal 1 located within a certain distance from the gate mechanism 31 associated with the terminal communication apparatus 35. On the other hand, the gate detection signal is, for example, a signal that cannot be received (in other words, cannot be detected) by the hearable terminal 1 located at the certain distance or more away from the gate mechanism 31 associated with the terminal communication apparatus 35. In a case where such a gate detection signal is transmitted, the hearable terminal 1, triggered by reception of the gate detection signal, becomes able to recognize that the hearable terminal 1 is located near the gate mechanism 31. In other words, the hearable terminal 1, triggered by reception of the gate detection signal, becomes able to recognize that the user U possessing the hearable terminal 1 is located near the gate mechanism 31.

### (3) Operation of Entry Management System SYS

Next, operation performed by the entry management system SYS is described. In the following, for the operation performed by the entry management system SYS, operation performed by the hearable terminal 1, operation performed by the entry management server 2, and operation performed by the access control apparatus 3 are described sequentially.

### (3-1) Operation of Hearable Terminal 1

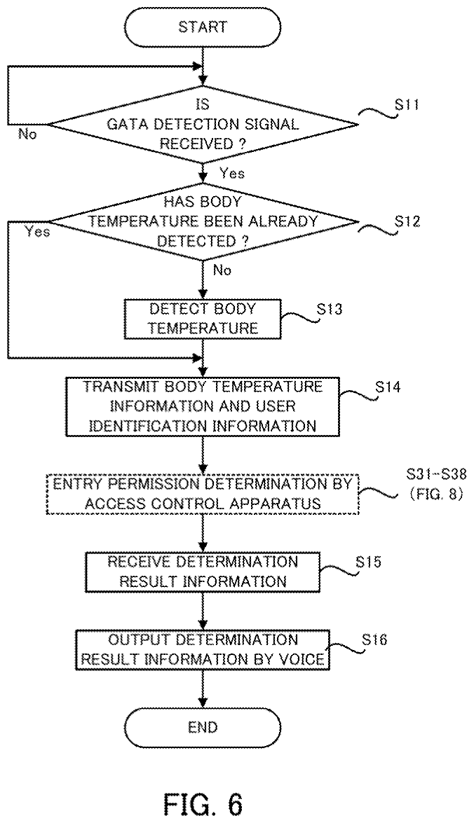

First, the operation performed by the hearable terminal 1 is described with reference to FIG. 6. FIG. 6 is a flowchart showing a flow of the operation performed by the hearable terminal 1.

As shown in FIG. 6, the communication control unit 121 determines whether or not the gate detection signal transmitted (outputted) by the access control apparatus 3 is received by the communication apparatus 14 (step S11). As described above, the gate detection signal is a signal that the hearable terminal 1 located within a certain distance from the gate mechanism 31 can receive, whereas the hearable terminal 1 located at the certain distance or more away from the gate mechanism 31 cannot receive. Accordingly, it may be considered that the operation of determining whether or not the gate detection signal is received by the communication apparatus 14 is substantially equivalent to operation of determining whether or not the hearable terminal 1 is located within the certain distance from the gate mechanism 31. It may be considered that the operation of determining whether or not the gate detection signal is received by the communication apparatus 14 is substantially equivalent to operation of determining whether or not the user U is located near the gate mechanism 31.

In a case where it is determined, as a result of the determination in step S11, that the gate detection signal is not received by the communication apparatus 14 (step S11: No), it is presumed that the user U is not located near the gate mechanism 31. In other words, it is presumed that there is no possibility that the user U is about to enter the management target area MTA from now. Accordingly, it is presumed that the entry management system SYS does not need yet to determine whether or not to permit entry of the user U into the management target area MTA. Accordingly, in such a case, the communication control unit 121 continues to determine whether or not the gate detection signal is received by the communication apparatus 14 (step S11).

In a case where it is determined, as a result of the determination in step S11, that the gate detection signal is received by the communication apparatus 14 (step S11: Yes), it is presumed that the user U is located near the gate mechanism 31. In other words, it is presumed that there is a possibility that the user U is about to enter the management target area MTA from now. Accordingly, it is presumed to be preferable that the entry management system SYS determine whether or not to permit entry of the user U into the management target area MTA. Accordingly, in such a case, the body temperature sensor 11 detects a body temperature of the user U (step S13). However, in a case where the body temperature sensor 11 has already detected a body temperature of the user U (step S12: Yes), the body temperature sensor 11 does not need to detect a body temperature of the user U. In other words, in a case where the body temperature sensor 11 has not yet detected a body temperature of the user U (step S12: No), the body temperature sensor 11 may detect a body temperature of the user U.

Thereafter, the communication control unit 121 transmits, to the access control apparatus 3 by using the communication apparatus 14, body temperature information related to the body temperature of the user U detected by the body temperature sensor 11 in step S12 (or the body temperature of the user U already detected by the body temperature sensor 11) (step S14).

In addition to the body temperature information, the communication control unit 121 transmits user identification information for identifying the user U to the access control apparatus 3 by using the communication apparatus 14 (step S14). The user identification information may be stored in the storage apparatus 13 of the hearable terminal 1. In such a case, the communication control unit 121 may transmit the user identification information stored in the storage apparatus 13.

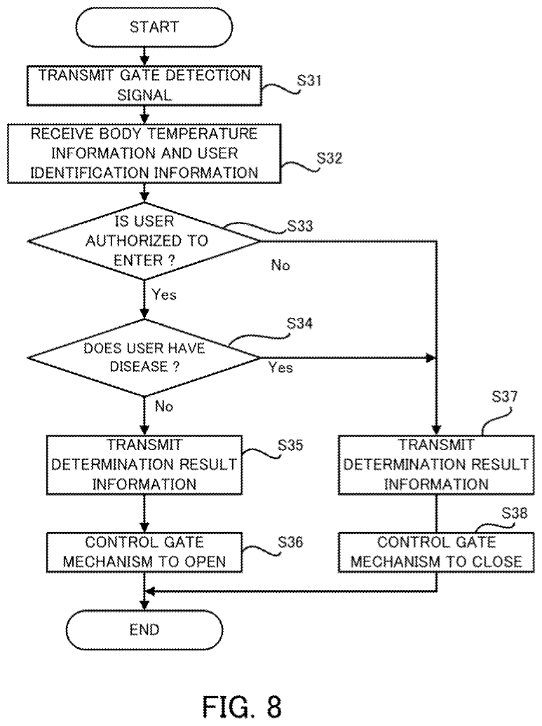

Thereafter, the access control apparatus 3 determines, based on the body temperature information (and further the user identification information) transmitted in step S14, whether or not to permit entry of the user U into the management target area MTA. Note that the operation of the access control apparatus 3 will be described in detail later with reference to FIG. 8, and a description thereof is therefore omitted here.

Thereafter, the communication control unit 121 receives, from the access control apparatus 3 by using the communication apparatus 14, the determination result information related to a result of determination as to whether or not to permit entry of the user U into the management target area MTA (step S15).

Thereafter, the notification control unit 122 controls the speaker 15 in such a manner that the determination result information received by the communication control unit 121 in step S15 is notified to the user U (step S16). Accordingly, the speaker 15 outputs the determination result information by using voice (step S16). As a result, the user U can aurally recognize the determination result information via the speaker 15. Note that a specific example of the determination result information will be described later in conjunction with a description of the operation of the access control apparatus 3, and a detailed description thereof is therefore omitted here.

### (3-2) Operation of Entry Management Server 2

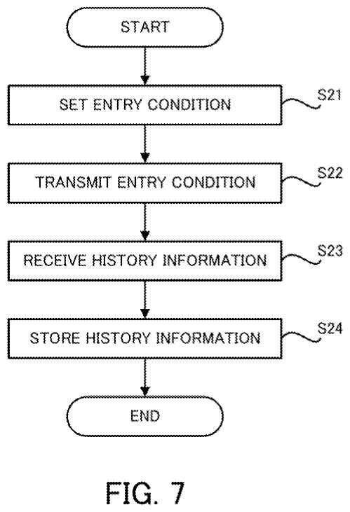

Next, the operation performed by the entry management server 2 is described with reference to FIG. 7. FIG. 7 is a flowchart showing a flow of the operation performed by the entry management server 2.

As shown in FIG. 7, the condition setting unit 211 sets an entry condition (step S21). Thereafter, the condition delivery unit 212 transmits (delivers) the entry condition set by the condition setting unit 211 in step S21 to the access control apparatus 3 (step). The entry condition delivered by the condition delivery unit 212 is used for the access control apparatus 3 to determine whether or not to permit entry of a user U into the management target area MTA.

In parallel with, or before or after, the setting and transmission of the entry condition, the history management unit 213 receives, from the access control apparatus 3 through the communication network 4, the history information related to an archival record of a result of determination as to whether or not to permit entry of the user U into the management target area MTA (step S23). The history management unit 213 stores the history information received in step S23 in the storage apparatus 22 (step S24). The history information stored in the storage apparatus 22 may be referred to by the history management unit 213 in a case where necessary.

### (3-3) Operation of Access Control Apparatus 3

Next, the operation performed by the access control apparatus 3 is described with reference to FIG. 8. FIG. 8 is a flowchart showing a flow of the operation performed by the access control apparatus 3.

As shown in FIG. 8, after the entry management system SYS starts operation, the terminal communication apparatus 35 continues to transmit the gate detection signal (step S31). Accordingly, operations in steps S32 to S35 described below are performed, typically, in a state where the gate detection signal is transmitted.

In a case where the gate detection signal transmitted in step S31 is received by the hearable terminal 1, the hearable terminal 1 transmits the body temperature information and the user identification information to the access control apparatus 3 as described above. As a result, the information acquisition unit 321 receives the body temperature information and the user identification information from the hearable terminal 1 by using the terminal communication apparatus 35 (step S32).

Thereafter, the determination unit 322 determines, based on each of the body temperature information and the user identification information received in step S32, whether or not to permit entry of the user U into the management target area MTA (steps S33 to S34).

Specifically, the determination unit 322 may determine whether or not to permit entry of the user U into the management target area MTA by determining, based on the user identification information, whether or not the user U is authorized to enter the management target area MTA (step S33). In such a case, the determination unit 322 may determine whether or not the user U is authorized to enter the management target area MTA, for example, based on an entry authorization policy indicating authorization to enter the management target area MTA, and on the user identification information received in step S32.

The entry authorization policy may include a white list. The white list may include a list of users U (for example, a list of user identification information) who are authorized to enter the management target area MTA. The white list may include information related to an attribute of each user U who is authorized to enter the management target area MTA (for example, at least one of duties of the user U, a department to which the user U belongs, and an employment type of the user U). The white list may include information related to time (for example, at least one of hours, a day of week, and a period) during which each user U can enter the management target area MTA. The white list may include information related to an entrance-exit through which each user U can enter the management target area MTA.

The entry authorization policy may include a black list. The black list may include a list of users U (for example, a list of user identification information) who are not authorized to enter the management target area MTA (that is, who should be restrained from entering the management target area MTA). The black list may include information related to an attribute of each user U who is not authorized to enter the management target area MTA (for example, at least one of duties of the user U, a department to which the user U belongs, and an employment type of the user U). The black list may include information related to time (for example, at least one of hours, a day of week, and a period) during which each user U cannot enter the management target area MTA. The black list may include information related to an entrance-exit through which each user U cannot enter the management target area MTA.

The entry authorization policy may be included in the entry condition set by the entry management server 2 (particularly, the condition setting unit 212). The condition setting unit 212 may generate beforehand the entry condition including the entry authorization policy before the entry management system SYS starts operation. The condition setting unit 212 may updates the entry condition including the entry authorization policy after the entry management system SYS starts operation.

Moreover, the determination unit 322 may determine whether or not to permit entry of the user U into the management target area MTA by determining, based on the body temperature information, whether or not there is a possibility that the user U has a disease (step S23). For example, the determination unit 322 may determine that there is a possibility that the user U has a disease in a case where a body temperature indicated by the body temperature information exceeds a predetermined first temperature threshold value (for example, 37.5 degrees Celsius). For example, the determination unit 322 may determine that there is no possibility that the user U has a disease in a case where a body temperature indicated by the body temperature information is lower than a predetermined second temperature threshold value. The second temperature threshold value is set to a value equal to or less than the first temperature threshold value. The second temperature threshold value may be set to the same value as the first temperature threshold value (for example, 37.5 degrees Celsius). Alternatively, the second temperature threshold value may be set to a different value from the first temperature threshold value (that is, a value less than the first temperature threshold value, which is, for example, 37.0 degrees Celsius).

At least one of the first and second temperature threshold values may be included in the entry condition (particularly, the biological condition that is the entry condition related to the biological information) set by the entry management server 2 (particularly, the condition setting unit 212). The condition setting unit 212 may generate beforehand the entry condition including at least one of the first and second temperature threshold values before the entry management system SYS starts operation. The condition setting unit 212 may update the entry condition including at least one of the first and second temperature threshold values after the entry management system SYS starts operation. In other words, the condition setting unit 212 may change at least one of the first and second temperature threshold values. For example, the access control apparatus 3 may determine whether or not there is a possibility that a user U whose normal body temperature is relatively high has a disease in some cases, and may determine whether or not there is a possibility that a user U whose normal body temperature is relatively low has a disease in other cases. In such cases, the condition setting unit 212 may change the first temperature threshold value in such a manner that a first temperature threshold value that is used to determine whether or not there is a possibility that the user U whose normal body temperature is relatively high has a disease, becomes more than a first temperature threshold value that is used to determine whether or not there is a possibility that the user U whose normal body temperature is relatively low has a disease. The condition setting unit 212 may change the second temperature threshold value in such a manner that a second temperature threshold value that is used to determine whether or not there is a possibility that the user U whose normal body temperature is relatively high has a disease, becomes more than a second temperature threshold value that is used to determine whether or not there is a possibility that the user U whose normal body temperature is relatively low has a disease. Note that for the normal body temperature of a user U, an average value of body temperatures of the user U for a predetermined time period in the past (for example, latest one hour or latest one day) may be used. In such a case, to calculate the normal body temperature of the user U, the body temperature sensor 11 of the hearable terminal 1 may consecutively detect a body temperature of the user U. In a case where the condition setting unit 212 sets the entry condition based on the body temperature of the user U, the hearable terminal 1 may transmit the body temperature information to the entry management server 2, in addition to the access control apparatus 3.

Alternatively, the condition setting unit 212 may change at least one of the first and second temperature threshold values, based on a combination of the body temperature information received in step S32 (that is, the current or latest body temperature of the user U) and a past body temperature of the user U. Alternatively, in addition to, or in place of, changing at least one of the first and second temperature threshold values, 322 may determine whether or not there is a possibility that the user U has a disease, based on the combination of the current or latest body temperature of the user U and the past body temperature of the user U. The determination unit 322 may determine that there is a possibility that the user U has a disease in a case where the current or latest body temperature of the user U is higher than the past body temperature of the user U by a predetermined third temperature threshold value or more.

It is determined, as a result of the determination in steps S33 and S34, that the user U is authorized to enter the management target area MTA and there is no possibility that the user U has a disease (step S33: Yes, and step S34: No), the determination unit 322 determines to permit entry of the user U into the management target area MTA. In such a case, the notification control unit 323 transmits, to the hearable terminal 1 by using the terminal communication apparatus 35, the determination result information related to the result of determination that entry of the user U into the management target area MTA is permitted (step S35).

The determination result information may include information indicating the result of determination itself. In other words, the determination result information may include information indicating the exact result of determination that entry of the user U into the management target area MTA is permitted. In such a case, the speaker 15 of the hearable terminal 1 having received such determination result information may output voice for notifying the user U of the exact result of determination that entry of the user U into the management target area MTA is permitted. For example, the speaker 15 may output the voice: “You (user U) can enter the management target area MTA.” As a result, the user U can recognize the fact that the user U is permitted to enter the management target area MTA.

The determination result information may include information indicating a reason (that is, a ground) for reaching the result of determination. In other words, the determination result information may include information indicating a reason why the access control apparatus 3 determines to permit entry of the user U into the management target area MTA. In such a case, the speaker 15 of the hearable terminal 1 having received such determination result information may output voice for notifying the user U of the reason why the entry management server 2 determines to permit entry of the user U into the management target area MTA. For example, the speaker 15 may output the voice: “You (user U) can enter the management target area MTA because there is no possibility that you have a disease.” For example, the speaker 15 may output the voice: “You (user U) can enter the management target area MTA because you are authorized to enter the management target area MTA.” As a result, the user U can recognize the reason why the user U is permitted to enter the management target area MTA.

In parallel with, or immediately before or after, the operation in step S35, the gate control unit 324 sets the state of the gate mechanism 31 to the non-restraint state in which the gate mechanism 31 permits (that is, does not restrain) entry of the user U into the management target area MTA (step S36). As a result, since the gate mechanism 31 does not restrain the user U from entering the management target area MTA, the user U can enter the management target area MTA.

In a case where it is determined, as a result of the determination in steps S33 and S34, that the user U is not authorized to enter the management target area MTA and/or there is a possibility that the user U has a disease (step S33: No, and/or step S34: Yes), the determination unit 322 determines not to permit entry of the user U into the management target area MTA. In such a case, the notification control unit 323 transmits, to the hearable terminal 1 by using the terminal communication apparatus 35, the determination result information related to the result of determination that entry of the user U into the management target area MTA is not permitted (step S37).

The determination result information may include information indicating the result of determination itself. In other words, the determination result information may include information indicating the exact result of determination that entry of the user U into the management target area MTA is not permitted. In such a case, the speaker 15 of the hearable terminal 1 having received such determination result information may output voice for notifying the user U of the exact result of determination that entry of user U into the management target area MTA is not permitted. For example, the speaker 15 may output the voice: “You (user U) cannot enter the management target area MTA.” As a result, the user U can recognize the fact that the user U is not permitted to enter the management target area MTA.

The determination result information may include information indicating a reason (that is, a ground) for reaching the result of determination. In other words, the determination result information may include information indicating a reason why the access control apparatus 3 determines not to permit entry of the user U into the management target area MTA. In such a case, the speaker 15 of the hearable terminal 1 having received such determination result information may output voice for notifying the user U of the reason why the entry management server 2 determines not to permit entry of the user U into the management target area MTA. For example, the speaker 15 may output the voice: “You (user U) cannot enter the management target area MTA because there is a possibility that you have a disease.” For example, the speaker 15 may output the voice: “You (user U) cannot enter the management target area MTA because you are not authorized to enter the management target area MTA.” As a result, the user U can recognize the reason why the user U is not permitted to enter the management target area MTA.

In a case where entry of the user U into the management target area MTA is not permitted, the gate control unit 324 sets the state of the gate mechanism 31 to the restraint state in which the gate mechanism 31 restrains entry of the user U into the management target area MTA (step S38). Accordingly, the user U cannot enter the management target area MTA.

### (4) Technical Effects of Entry Management System SYS

As described above, the access control apparatus 3 notifies the determination result information to the user U by using the hearable terminal 1. Accordingly, the determination result information is notified to the one user U wearing the hearable terminal 1, whereas the determination result information is not notified to another user U who does not wear the hearable terminal 1. In other words, the determination result information is notified to the one user U to which the determination result information should be notified, whereas the determination result information is not notified to another user U to which the determination result information should not be notified. Accordingly, personal information on the one user U including a result of determination as to whether or not entry of the user U into the management target area MTA is permitted is not leaked to another user U unintentionally. Consequently, the user personal information is appropriately protected. For example, even if the access control apparatus 3 determines not to permit entry of the user U into the management target area MTA, based on a reason that might defame the user U, might abuse human rights of the user U, might violate privacy of the user, and/or might lead to leakage of personal information on the user U, the personal information on the user U related to the result of determination that might defame the user U, might abuse human rights of the user U, might violate privacy of the user, and/or might lead to leakage of the personal information on the user U is appropriately protected.

In the present example embodiment, the access control apparatus 3 determines whether or not to permit entry of a user U into the management target area MTA, based on the body temperature information related to the body temperature of the user U, and on the user identification information. Accordingly, even if at least part of the face of the user U is concealed, the access control apparatus 3 can determine whether or not to permit entry of the user U into the management target area MTA. For example, even if the user U wears a mask, the access control apparatus 3 can determine whether or not to permit entry of the user U into the management target area MTA. Accordingly, the access control apparatus 3 does not need to ask the user U whose face is at least partially concealed to expose the face. Consequently, operation of the access control apparatus 3 is simplified, as compared to an access control apparatus in a comparison example that needs to ask a user U whose face is at least partially concealed to expose the face. Moreover, since the user U does not need either to expose the concealed at least part of the face (for example, to remove the mask), convenience of the user U is also enhanced.

### (5) Modifications

Next, modifications of the entry management system SYS are described.

### (5-1) First Modification

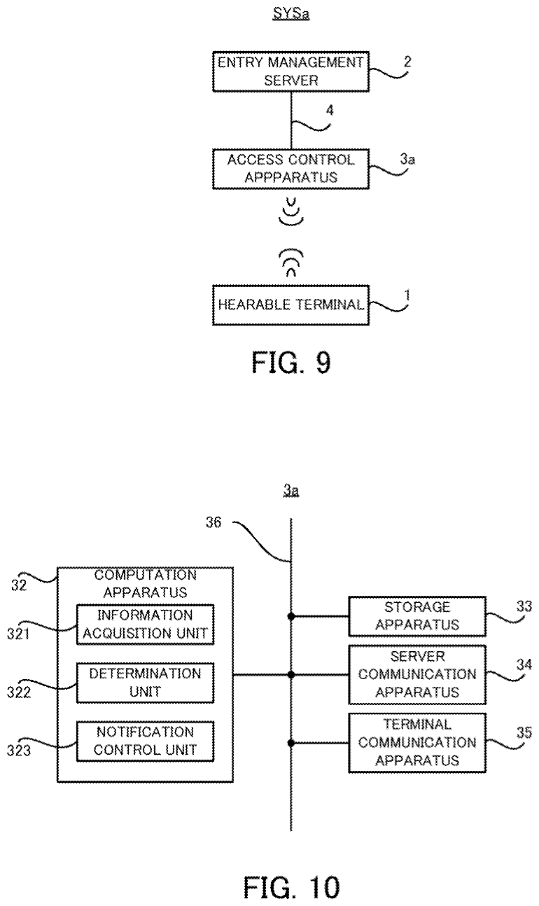

First, an entry management system SYS in a first modification is described with reference to FIG. 9. An entry management system SYS in a first modification is described with reference to FIG. 9. Note that in the following, the entry management system SYS in the first modification is referred to as “entry management system SYSa,” and thereby distinguished from the above-described entry management system SYS. In the following description, the constituent elements that have been already described are denoted by the same reference numbers, whereby a detailed description thereof is omitted.

As shown in FIG. 9, the entry management system SYSa in the first modification is different than the above-described entry management system SYS in that the entry management system SYSa includes an access control apparatus 3a in place of the access control apparatus 3. The other characteristics of the entry management system SYSa may be the same as the other characteristics of the entry management system SYS.

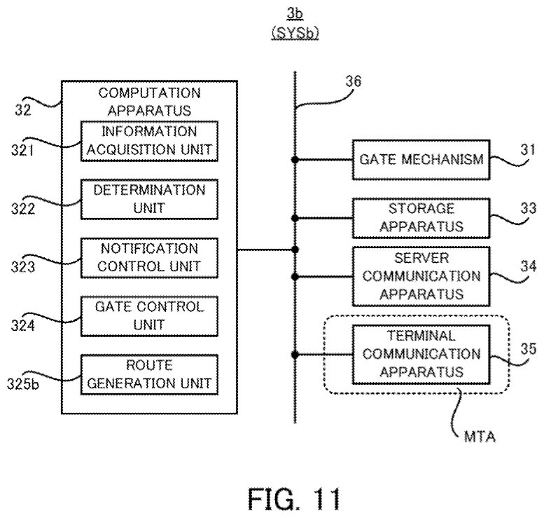

A configuration of the access control apparatus 3a in the first modification is shown in FIG. 10. As shown in FIG. 10, the access control apparatus 3a is different than the above-described access control apparatus 3 in that the access control apparatus 3a may omit to include the gate mechanism 31 and the gate control unit 324. In other words, the access control apparatus 3a is different than the entry management server 2 in that the access control apparatus 3a does not need to perform the operations in steps S36 and S38 in FIG. 8 (that is, the operations for controlling the gate mechanism 31). The other characteristics of the access control apparatus 3a may be the same as the other characteristics of the access control apparatus 3.

In the first modification as described above, the access control apparatus 3a also notifies the determination result information to the user U by using the hearable terminal 1. Accordingly, in the first modification, similar effects to the above-described effects that can be brought about by the entry management system SYS can also be brought above.

Note that in the first modification, since the access control apparatus 3a does not include the gate mechanism 31, entry of a user into the management target area MTA is not physically restrained (for example, blocked). However, in a case where the access control apparatus 3a determines not to permit entry of a user U into the management target area MTA, the user is notified of the determination result information related to the result of determination that entry of the user U into the management target area MTA is not permitted. Such notification of the determination result information to the user U can serve as a deterrent for restraining the user U from entering the management target area MTA. Accordingly, even if the access control apparatus 3a does not include the gate mechanism 32, the entry management system SYSa can substantially manage (for example, restrain) entry of a user U into the management target area MTA as long as the determination result information is notified.

### (5-2) Second Modification

Next, an entry management system SYS in a second modification is described. Note that in the following, the entry management system SYS in the second modification is referred to as “entry management system SYSb,” and thereby distinguished from the above-described entry management system SYS. The above-described entry management system SYS is capable of managing entry of a user U into the management target area MTA before the user U enters the management target area MTA. In contrast, the entry management system SYSb in the second modification is different than the above-described entry management system SYS in that in addition to, or in place of, the capability of managing entry of a user U into the management target area MTA before the user U enters the management target area MTA, the entry management system SYSb is capable of managing stay of the user U in the management target area MTA after the user U enters the management target area MTA. Specifically, the entry management system SYSb is capable of acquiring biological information (for example, body temperature information) on the user U staying in the management target area MTA and, based on the acquired biological information, determining whether or not to permit stay of the user U in the management target area MTA.

Moreover, the entry management system SYSb may be different than the above-described entry management system SYS in that in a case where determining not to permit stay of the user U in the management target area MTA, the entry management system SYSb is capable of notifying the user U of route information related to an exit route that the user U should follow to exit the management target area MTA. However, the entry management system SYSb does not need to be capable of notifying the route information to the user U.

In order to determine whether or not to permit stay of a user U in the management target area MTA and to notify the route information to the user U, the entry management system SYSb is different than the above-described entry management system SYS in that the entry management system SYSb includes an access control apparatus 3b in place of the access control apparatus 3. The other characteristics of the entry management system SYSb may be the same as the other characteristics of the entry management system SYS. Accordingly, in the following, the access control apparatus 3b in the second modification is described with reference to FIG. 11. FIG. 11 is a block diagram showing a configuration of the access control apparatus 3b in the second modification.

As shown in FIG. 11, the access control apparatus 3b is different than the above-described access control apparatus 3 in that the access control apparatus 3b may include a route generation unit 215b capable of generating the route information and notifying the route information to the user U. The other characteristics of the access control apparatus 3b may be the same as the other characteristics of the entry management server 2.

However, in order to manage stay of a user U in the management target area MTA after the user U enters the management target area MTA, the access control apparatus 3b needs to receive the body temperature information from the user U staying in the management target area MTA and to transmit the determination result information to the user U staying in the management target area MTA. To this end, in the second modification, it is preferable that the access control apparatus 3b include the terminal communication apparatus 35 that is disposed within the management target area MTA. The terminal communication apparatus 35 disposed within the management target area MTA does not necessarily need to be disposed together with the gate mechanism 31. Note that in a case where the access control apparatus 3b does not manage entry of a user U into the management target area MTA before the user U enters the management target area MTA, the access control apparatus 3b may omit to include the gate mechanism 31 and the gate control unit 324.

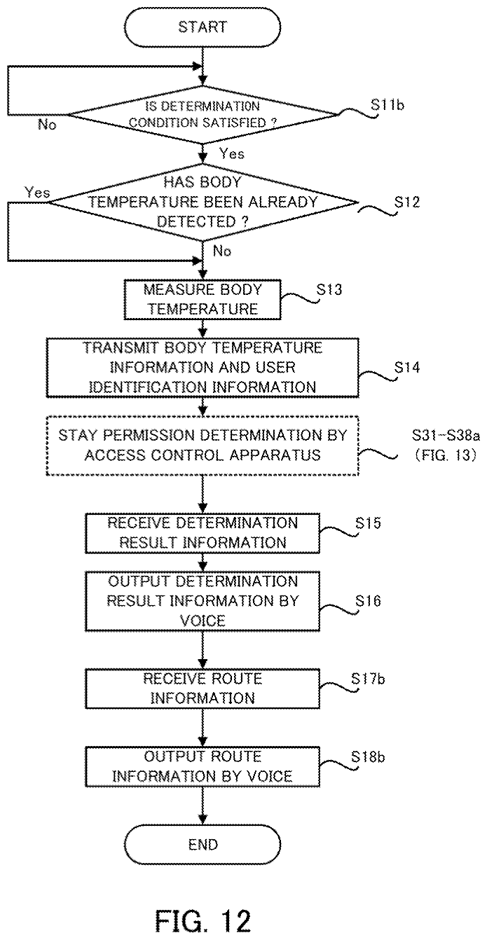

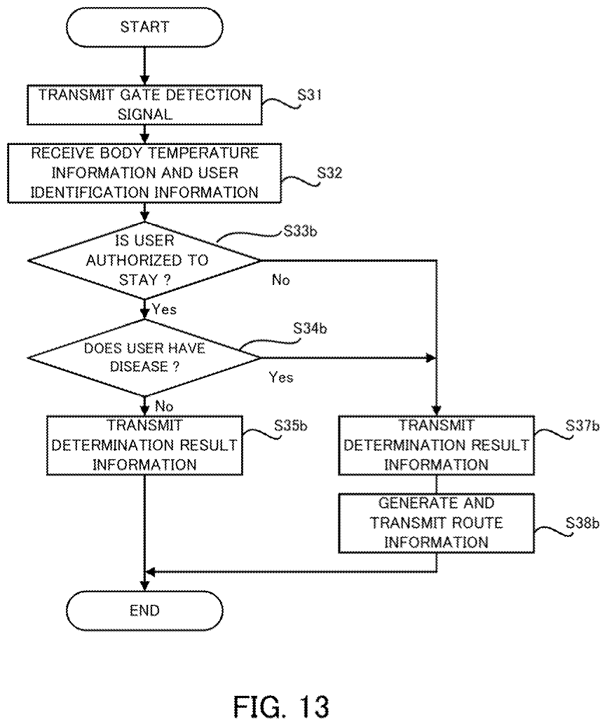

Next, operation of the hearable terminal 1 and operation of the access control apparatus 3b in the second modification are described with reference to FIGS. 12 and 13. FIG. 12 is a flowchart showing a flow of the operation performed by the hearable terminal 1 in the second modification. FIG. 13 is a flowchart showing a flow of the operation performed by the access control apparatus 3b in the second modification. Note that the operations shown in FIGS. 12 and 13 are performed typically after the user U enters the management target area MTA. In other words, the operations shown in FIGS. 12 and 13 are performed typically in at least part of a period during which the user U stays in the management target area MTA. The operations that have been already described are denoted by the same step numbers, whereby a detailed description thereof is omitted.

First, as shown in FIG. 12, the communication control unit 121 of the hearable terminal 1 determines whether or not a predetermined determination start condition is satisfied (step S11b). The determination start condition is a condition that should be satisfied for the access control apparatus 3b to start determining whether or not to permit stay of the user U in the management target area MTA. For example, the determination start condition may include a condition that a predetermined first time period passes after a user U enters the management target area MTA. For example, the determination start condition may include a condition that a predetermined second time period passes after the access control apparatus 3b last determines whether or not to permit stay of a user U in the management target area MTA. For example, the determination start condition may include a condition that an operator of the entry management server 2 desires that the access control apparatus 3b start determining whether or not to permit stay of a user U in the management target area MTA.

In a case where it is determined, as a result of the determination in step S11b, that the determination start condition is not satisfied (step S11b: No), the communication control unit 121 continues to determine whether or not the determination start condition is satisfied (step S11b).

In a case where it is determined, as a result of the determination in step S11b, that the determination start condition is satisfied (step S11b: Yes), the body temperature sensor 11 detects a body temperature of the user U (step S13). However, in a case where the body temperature sensor 11 has already detected a body temperature of the user U (step S12: Yes), the body temperature sensor 11 does not need to detect a body temperature of the user U. Thereafter, the communication control unit 121 transmits the body temperature information to the access control apparatus 3b by using the communication apparatus 14 (step S14). Further, the communication control unit 121 transmits the user identification information to the access control apparatus 3b by using the communication apparatus 14 (step S14).

As a result, as shown in FIG. 13, the information acquisition unit 321 of the entry management server 2 receives the body temperature information and the user identification information from the hearable terminal 1 by using the communication apparatus 23 (step S32).

Thereafter, based on each of the body temperature information and the user identification information received in step S21, the determination unit 322 of the entry management server 2 determines whether or not to permit stay of the user U in the management target area MTA (steps S33b to S34b).

Specifically, the determination unit 322 may determine whether or not to permit stay of the user U in the management target area MTA by determining, based on the user identification information, whether or not the user U is authorized to stay in the management target area MTA (step S33b). For example, the determination unit 322 may determine whether or not the user U is authorized to stay in the management target area MTA, based on a stay authorization policy indicating authorization to stay in the management target area MTA, and on the user identification information received in step S32. Note that the stay authorization policy may be similar data to the above-described entry authorization policy. In other words, the description related to the entry authorization policy given above can be used for a description related to the stay authorization policy, by replacing the word “entry” with the word “stay.” Accordingly, a detailed description of the stay authorization policy is omitted.

Further, the determination unit 322 may determine whether or not to permit stay of the user U in the management target area MTA by determining, based on the body temperature information, whether or not there is a possibility that the user U has a disease (step S34b). Note that the operation in step S34b may be the same as the above-described operation in step S34 in FIG. 8. In other words, the description related to the operation in step S34 in FIG. 8 given above can be used for a description related to the operation in step S34b, by replacing the word “entry” with the word “stay.” Accordingly, a detailed description of the operation in step S34b is omitted.

In a case where it is determined, as a result of the determination in steps S33b and S34b, that the user U is authorized to stay in the management target area MTA and there is no possibility that the user U has a disease (step S33b: Yes, and step S34b: No), the determination unit 322 determines to permit stay of the user U in the management target area MTA. In such a case, the notification control unit 323 transmits, to the hearable terminal 1 by using the terminal communication apparatus 35, the determination result information related to the result of determination that stay of the user U in the management target area MTA is permitted (step S35b). Note that the operation in step S35b may be the same as the above-described operation in step S35 in FIG. 8. In other words, the description related to the operation in step S35 in FIG. 8 given above can be used for a description related to the operation in step S35b, by replacing the word “entry” with the word “stay.” Accordingly, a detailed description of the operation in step S35b is omitted.

In a case where it is determined, as a result of the determination in steps S33b and S34b, that the user U is not authorized to stay in the management target area MTA and/or there is a possibility that the user U has a disease (step S33b: No, and/or step S34b: Yes), the determination unit 322 determines not to permit stay of the user U in the management target area MTA. In such a case, the notification control unit 323 transmits, to the hearable terminal 1 by using the terminal communication apparatus 35, the determination result information related to the result of determination that stay of the user U in the management target area MTA is not permitted (step S37b). Note that the operation in step S37b may be the same as the above-described operation in step S37 in FIG. 8. In other words, the description related to the operation in step S37 in FIG. 8 given above can be used for a description related to the operation in step S37b, by replacing the word “entry” with the word “stay.” Accordingly, a detailed description of the operation in step S37b is omitted.

In parallel with, or immediately before or after, the operation in step S37b, the route generation unit 325b generates the route information (step S38b). For example, the route generation unit 325b may generate the route information related to an exit route from a current position of the user U to the entrance-exit of the management target area MTA. For example, in a case where a plurality of entrances/exits is provided to the management target area MTA, the route generation unit 325b may generate the route information related to the exit route from the current position of the user U to an entrance-exit that is closest to the user U among the plurality of entrances/exits.

Thereafter, the route generation unit 325b transmits the route information to the hearable terminal 1 by using the terminal communication apparatus 35 (step S38b).

In a case where the access control apparatus 3b transmits the determination result information to the hearable terminal 1, as shown in FIG. 12, the communication control unit 121 of the hearable terminal 1 receives the determination result information from the access control apparatus 3b by using the communication apparatus 14 (step S15). Thereafter, the notification control unit 122 controls the speaker 15 in such a manner that the determination result information received by the communication control unit 121 in step S15 is notified to the user U (step S16).

Further, in a case where the access control apparatus 3b transmits the route information to the hearable terminal 1, as shown in FIG. 12, the communication control unit 121 of the hearable terminal 1 receives the route information from the access control apparatus 3b by using the communication apparatus 14 (step S17b). Thereafter, the notification control unit 122 controls the speaker 15 in such a manner that the route information received by the communication control unit 121 in step S17b is notified to the user U (step S18b). As a result, the user U can aurally recognize the route information via the speaker 15. In other words, the user U can recognize the exit route that the user U should follow in the management target area MTA in a case where making an exit. Accordingly, by following the exit route, the user U can exit (that is, leave) the management target area MTA to an outside of the management target area MTA.

As described above, in the second modification, the entry management server 2b determines whether or not to permit stay of a user U in the management target area MTA also after the user U enters the management target area MTA. Accordingly, in a case where the user U feels ill (for example, the body temperature of the user U increases) after the user U enters the management target area MTA, the entry management server 2b can urge the user U to exit the management target area MTA. Alternatively, in a case where authorization for the user U to stay in the management target area MTA expires after the user U enters the management target area MTA, the entry management server 2b can urge the user U to exit the management target area MTA. In such a case, since the determination result information is notified to the user U by using the hearable terminal 1, the personal information on the user U related to the result of determination is also appropriately protected.

The entry management server 2b is capable of notifying the user U of the route information related to the exit route that the user U should follow to exit the management target area MTA. Accordingly, the user U can smoothly exit the management target area MTA, as compared to a case where the route information is not notified to the user U.

Note that the access control apparatus 3b includes the route generation unit 325b in the above description. However, the entry management server 2 may include the route generation unit 325b. In such a case, the hearable terminal 1 may receive the route information generated by the route generation unit 325b of the entry management server 2.

Note that the above-described entry management system SYSa in the first modification may include a constituent element that is specific to the entry management system SYSb in the second modification. The constituent element that is specific to the entry management system SYSb in the second modification may include, for example, a constituent element related to management of stay of a user U in the management target area MTA. The constituent element specific to the entry management system SYSb in the second modification may include, for example, a constituent element related to generation and notification of the route information.

### (5-3) Third Modification

Next, an entry management system SYS in a third modification is described. Note that in the following, the entry management system SYS in the third modification is referred to as “entry management system SYSc,” and thereby distinguished from the above-described entry management system SYS. The entry management system SYSc in the third modification is different than the above-described entry management system SYSb in the second modification in that the route generation unit 325b may generate the route information related to an exit route that goes through an area where the number of users U staying therein is relatively small in the management target area MTA. In other words, in the third modification, the route generation unit 325b may generate the route information related to an exit route that goes through at least one partial area where the number of users U staying therein is relatively small, as compared to the other partial areas, in the management target area MTA. For example, in a case where a plurality of routes can be generated from a current position of the user U to the entrance-exit of the management target area MTA, the route generation unit 325b may select, as the exit route that the user U should follow, one route that goes through a partial area where the number of users staying therein is the smallest, among a plurality of routes. Note that the route generation unit 325b may calculate the number of users U staying in the management target area MTA, for example, based on an image captured by a surveillance camera for monitoring the management target area MTA. The route generation unit 215b may identify the partial area where the number of users U staying therein is relatively small, based on an image captured by the surveillance camera for monitoring the management target area MTA. The other characteristics of the entry management system SYSc may be the same as the other characteristics of the entry management system SYSb.

As described above, in the third modification, the entry management server 2b can notify the user U of the route information generated based on the number of staying users U. Accordingly, the number of users U who come in some contact with the user U in a case where the user U exits the management target area MTA is reduced, as compared to a case where the route information generated without taking the number of staying users U into consideration is notified to the user U. As a result, the probability is lowered that the user U who is not permitted to stay in the management target area MTA because there is a possibility that the user U has some disease transmits the disease to other users U.

### (5-4) Fourth Modification

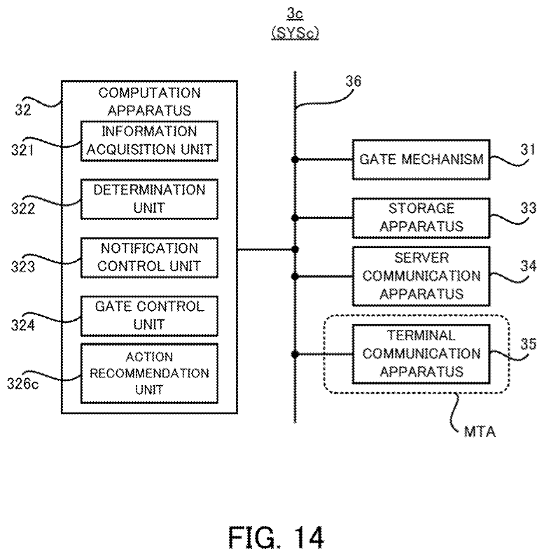

Next, an entry management system SYS in a fourth modification is described. In the following, the entry management system SYS in the fourth modification is referred to as “entry management system SYSd,” and thereby distinguished from the above-described entry management system SYS. The entry management system SYSd in the fourth modification is different than the above-described entry management system SYS in that in a case where it is determined that entry of a user U into the management target area MTA is not permitted, the entry management system SYSd is capable of notifying the user U of recommended action information related to an action that the user U is recommended to take thereafter. To notify the recommended action information to the user U, the entry management system SYSd is different than the above-described entry management system SYS in that the entry management system SYSd includes an access control apparatus 3d in place of the access control apparatus 3. The other characteristics of the entry management system SYSd may be the same as the other characteristic of the entry management system SYS. Accordingly, in the following, the access control apparatus 3c in the fourth modification is described with reference to FIG. 14. FIG. 14 is a block diagram showing a configuration of the access control apparatus 3c in the fourth modification.

As shown in FIG. 14, the access control apparatus 3c is different than the above-described access control apparatus 3 in that the access control apparatus 3c may include an action recommendation unit 326c capable of generating the recommended action information and notifying the recommended action information to the user U. The other characteristics of the access control apparatus 3c may be the same as the other characteristics of the access control apparatus 3.

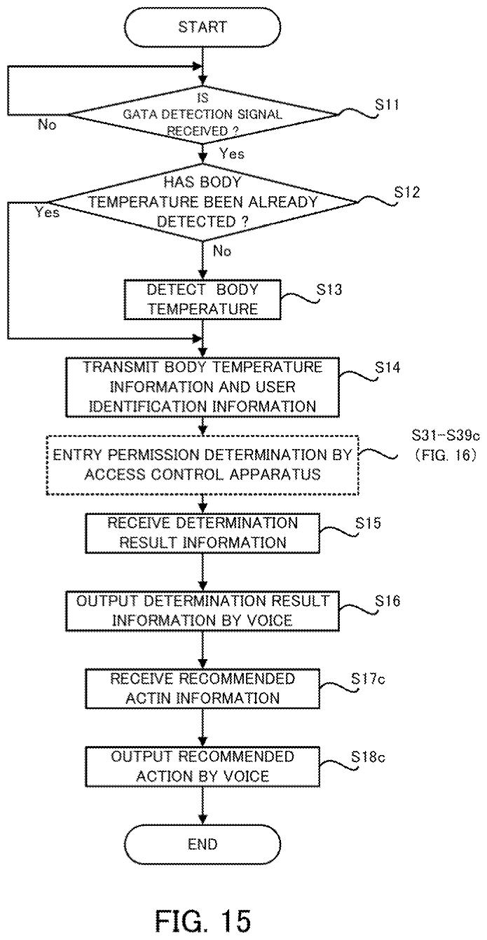

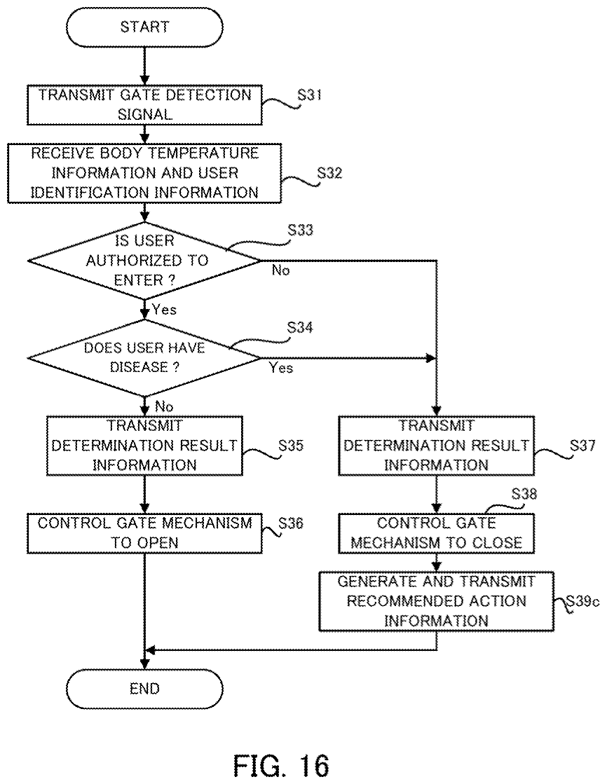

Next, operation of the hearable terminal 1 and operation of the access control apparatus 3c in the fourth modification are described with reference to FIGS. 15 and 16. FIG. 15 is a flowchart showing a flow of the operation performed by the hearable terminal 1 in the fourth modification. FIG. 16 is a flowchart showing a flow of the operation performed by the access control apparatus 3c in the fourth modification.

First, as shown in FIG. 15, the hearable terminal 1 performs the operations in steps S11 to S14 also in the fourth modification. In other words, the communication control unit 121 determines whether or not the gate detection signal is received by the communication apparatus 14 (step S11), the body temperature sensor 11 detects a body temperature of the user U (steps S12 to S13), and the communication control unit 121 transmits the body temperature information and the user identification information to the access control apparatus 3c.

As a result, as shown in FIG. 16, the information acquisition unit 321 of the access control apparatus 3c receives the body temperature information and the user identification information from the hearable terminal 1 by using the terminal communication apparatus 35 (step S32). Thereafter, the access control apparatus 3c performs the operations in steps S33 to S38 also in the fourth modification. In other words, the determination unit 322 determines, based on each of the body temperature information and the user identification information, whether or not to permit entry of the user U into the management target area MTA (steps S33 to S34). In a case where it is determined that entry of the user U into the management target area MTA is permitted, the notification control unit 323 transmits, to the hearable terminal 1, the determination result information related to the result of determination that entry of the user U into the management target area MTA is permitted (step S35), and the gate control unit 324 sets the state of the gate mechanism 31 to the non-restraint state (step S36). In a case where it is determined that entry of the user U into the management target area MTA is not permitted, the notification control unit 323 transmits, to the hearable terminal 1, the determination result information related to the result of determination that entry of the user U into the management target area MTA is not permitted (step S37), and the gate control unit 324 sets the state of the gate mechanism 31 to the restraint state (step S38).

In parallel with, or immediately before or after, the operations in steps S37 to S38, the action recommendation unit 326c generates the recommended action information (step S39c). For example, the action recommendation unit 326c may generate such recommended action information as to prevent an action of the user U who acts according to the recommended action information from being an action expected to be generally taken by a user U who is not permitted to enter the management target area MTA. As an example, a look of surprise might appear on the face of a user U who is not permitted to enter the management target area MTA, in response to the fact that entry into the management target area MTA is not permitted. Accordingly, for example, the action recommendation unit 216c may generate such recommended action information as to recommend the user U to take an action of walking away from the entrance-exit and going back, pretending not to know. As another example, if the user U who is not permitted to enter the management target area MTA passes many other users U on a way back, the action of the user U walking in a direction opposite to the entrance-exit as a result of being not permitted to enter the management target area MTA might attract attention of many users U. As a result, some users U might notice that the user U walking in the direction opposite to the entrance-exit is a user U who is not permitted to enter the management target area MTA. Accordingly, for example, the action recommendation unit 326c may generate such recommended action information as to allow the user U to go back by passing through an area where the number of other users U is relatively small.

In a case where the access control apparatus 3c transmits the determination result information to the hearable terminal 1, as shown in FIG. 15, the communication control unit 121 of the hearable terminal 1 receives the determination result information from the access control apparatus 3c (step S15). Thereafter, the notification control unit 122 controls the speaker 15 in such a manner that the determination result information received by the communication control unit 121 in step S15 is notified to the user U (step S16).

Further, in a case where the access control apparatus 3c transmits the recommended action information to the hearable terminal 1, as shown in FIG. 15, the communication control unit 121 of the hearable terminal 1 receives the recommended action information from the access control apparatus 3c by using the communication apparatus 14 (step S17c). Thereafter, the notification control unit 122 controls the speaker 15 in such a manner that the recommended action information received by the communication control unit 121 in step S17c is notified to the user U (step S18c). As a result, the user U can aurally recognize the recommended action information via the speaker 15. In other words, the user U can recognize the action recommended to take from now. Accordingly, the user U can take the action recommended by the recommended action information.

As described above, in the fourth modification, the access control apparatus 3c is capable of notifying the recommended action information to the user U. As described above, the recommended action information is generated such that an action of the user U who acts according to the recommended action information is prevented from being an action expected to be generally taken by a user U who is not permitted to enter the management target area MTA. Accordingly, in a case where the user U acts according to the recommended action information, the action of the user U is different from the action expected to be generally taken by a user U who is not permitted to enter the management target area MTA, as compared to a case where the user U acts on instinct, not according to the recommended action information. As a result, the probability is lowered that other users U notice that the user U walking in the direction opposite to the entrance-exit is a user U who is not permitted to enter the management target area MTA. As a result, the personal information on the user U related to the result of determination is appropriately protected.

Note that in the above description, the access control apparatus 3c includes the action recommendation unit 326c. However, the entry management server 2 may include the action recommendation unit 326c. In such a case, the hearable terminal 1 may receive the recommended action information generated by the action recommendation unit 326c of the entry management server 2.

Note that the entry management system SYSa in the first modification and the entry management system SYSb in the second modification described above may include a constituent element specific to the entry management system SYSc in the third modification. The constituent element specific to the entry management system SYSc in the third modification may include, for example, a constituent element related to generation and notification of the recommended action information.

### (5-5) Other Modifications

### (5-5-1) Modification of Hearable Terminal 1

In the above description, one hearable terminal 1 performs all of: body temperature detection operation of detecting a body temperature of the user U; user identification operation of acquiring the user identification information; communication operation of transmitting the body temperature information and the user identification information to the entry management server 2 and receiving the determination result information; and notification operation of notifying the determination result information to the user U. However, the entry management system SYS may separately include a hearable terminal 1 (or an arbitrary user terminal) that performs at least one of the body temperature detection operation, the user identification operation, the communication operation, and the notification operation, and a hearable terminal 1 (or an arbitrary user terminal) that performs at least another one of the body temperature detection operation, the user identification operation, the communication operation, and the notification operation. The user U may separately possess a hearable terminal 1 (or an arbitrary user terminal) that performs at least one of the body temperature detection operation, the user identification operation, the communication operation, and the notification operation, and a hearable terminal 1 (or an arbitrary user terminal) that performs at least another one of the body temperature detection operation, the user identification operation, the communication operation, and the notification operation.

As an example, the user U may have a hearable terminal 1 and a smartphone paired with the hearable terminal 1. The hearable terminal 1 may perform the body temperature detection operation and the notification operation. On the other hand, the smartphone may perform the communication operation. In such a case, the body temperature information related to a body temperature of the user U detected by the hearable terminal 1 may be transmitted from the hearable terminal 1 to the access control apparatus 3 via the smartphone. The determination result information transmitted from the access control apparatus 3 may be transmitted from the access control apparatus 3 to the hearable terminal 1 via the smartphone.

In the above description, the hearable terminal 1 unconditionally notifies the determination result information received from the access control apparatus 3 to the user U. However, the hearable terminal 1 may notify the determination result information to the user U in a case where a predetermined notification condition is satisfied, whereas the hearable terminal 1 does not need to notify the determination result information to the user U in a case where the predetermined notification condition is not satisfied. For example, the notification condition may include a condition that the user identification information included in the determination result information matches the user identification information on the user U possessing the hearable terminal 1 that has received the determination result information. In such a case, the notification control unit 323 of the access control apparatus 3 may transmit, to the hearable terminal 1, the determination result information including the user identification information for identifying the user U to which the determination result information should be notified. In a case where the user identification information included in the determination result information does not match the user identification information on the user U possessing the hearable terminal 1 that has received the determination result information, there is a possibility that the determination result information transmitted by the access control apparatus 3 is transmitted to a hearable terminal 1 possessed by another user U who is different from the user U to which the determination result information should be notified. In such a case, if the determination result information is notified to the other user U, the personal information on the user U included in the determination result information can be leaked to the other user U. Accordingly, in a case where the user identification information included in the determination result information does not match the user identification information on the user U possessing the hearable terminal 1 that has received the determination result information, the notification control unit 122 of the hearable terminal 1 does not need to control the speaker 15 in such a manner that the determination result information is notified. As a result, the personal information on the user U is appropriately protected.

In the above description, in a case where the communication apparatus 14 detects the gate detection signal, the hearable terminal 1 transmits the body temperature information and the user identification information to the access control apparatus 3. In other words, in a case where the user U is located near the gate mechanism 31, the hearable terminal 1 transmits the body temperature information and the user identification information to the access control apparatus 3. However, even in a case where the communication apparatus 14 does not detect the gate detection signal, the hearable terminal 1 may transmit the body temperature information and the user identification information to the access control apparatus 3. Even in a case where the user U is not located near the gate mechanism 31, the hearable terminal 1 may transmit the body temperature information and the user identification information to the access control apparatus 3. The hearable terminal 1 may transmit the body temperature information and the user identification information to the access control apparatus 3, at a desired timing. For example, the hearable terminal 1 may transmit the body temperature information and the user identification information to the access control apparatus 3, at a timing in a case where the user U puts the hearable terminal 1 on. For example, the hearable terminal 1 may transmit the body temperature information and the user identification information to the access control apparatus 3, before, or at a timing in a case where, the user U departs from home in order to enter the management target area MTA. In such a case, before the user U actually visits the management target area MTA, the user U can recognize whether or not entry into the management target area MTA is permitted. Accordingly, the user U does not need to take an unnecessary action of visiting the management target area MTA, as compared to a case where the user U recognizes whether or not entry into the management target area MTA is permitted for the first time after the user U visits the management target area MTA. Accordingly, convenience of the user U is enhanced.

In the above description, in a case where the body temperature sensor 11 detects a body temperature, the hearable terminal 1 unconditionally transmits the body temperature information related to the detected body temperature to the access control apparatus 3. However, the hearable terminal 1 may perform operation of authenticating (for example, biologically authenticating) the user U whose body temperature is being detected, in at least part of a period during which the body temperature sensor 11 detects the body temperature. Alternatively, for example, before the body temperature sensor 11 detects a body temperature, the hearable terminal 1 may perform operation for authenticating the user U whose body temperature is due to be detected, and after the body temperature sensor 11 detects the body temperature, the hearable terminal 1 may perform operation for authenticating the user U whose body temperature has been detected. In such a case, the operations for authenticating the user U may be performed to prevent theft of the identity of the user U. In other words, the operations for authenticating the user U may be performed to prevent a user U who is different from the user U possessing (typically, wearing) the hearable terminal 1 from impersonating the user U possessing (typically, wearing) the hearable terminal 1. As a result, the probability is lowered that the body temperature information related to a body temperature of the user U who is different from the user U possessing (typically, wearing) the hearable terminal 1 is transmitted to the access control apparatus 3 as the body temperature information related to a body temperature of the user U possessing (typically, wearing) the hearable terminal 1.

Note that for an authentication method for authenticating the user U, an arbitrary authentication method can be adopted. For example, an authentication method may be used in which the user U is authenticated by comparing a characteristic of reflection in the Eustachian tube of the user U observed in a case where voice is outputted from the speaker 15 of the hearable terminal 1, with a pre-registered reflection characteristic of the user U.

### (5-5-2) Modification of Access Control Apparatus 3

In the above description, the access control apparatus 3 determines whether or not to permit entry of a user into the management target area MTA, based on the body temperature information. However, the access control apparatus 3 may determine whether or not to permit entry of a user into the management target area MTA, based on arbitrary biological information different from the body temperature information. An example of the arbitrary biological information different from the body temperature information is pulse information related to a pulse (for example, information related to a pulse rate). Another example of the arbitrary biological information different from the body temperature information is blood pressure information related to a blood pressure (for example, information related to at least one of a systolic blood pressure and a diastolic blood pressure). Another example of the arbitrary biological information different from the body temperature information is vocalization information related to a vocalization of the user (for example, information related to at least one of a voice volume, a voice pitch (that is, frequency), and a speech rate). Another example of the arbitrary biological information different from the body temperature information is motion information related to a body motion of the user (for example, information related to at least one of a gait rhythm of the user and a walking speed of the user). Another example of the arbitrary biological information different from the body temperature information is motion information related to an expression of the user (for example, information related to an action unit corresponding to a motion of at least one of a plurality of face parts included in the face of the user). In a case where the access control apparatus 3 uses the arbitrary biological information different from the body temperature information as described above, the hearable terminal 1 may include a sensor capable of detecting the arbitrary biological information different from the body temperature information, in addition to, or in place of, the body temperature sensor 11.

In the above description, the access control apparatus 3 acquires the body temperature information from the hearable terminal 1. However, the access control apparatus 3 may acquire the body temperature information from another apparatus different from the hearable terminal 1. In such a case, the hearable terminal 1 does not need to include the body temperature sensor 11. For example, the access control apparatus 3 may include a body temperature sensor disposed near the entrance-exit of the management target area MTA. In such a case, the body temperature sensor included in the access control apparatus 3 may detect a body temperature of a user U located near the access control apparatus 3 (particularly, near the gate mechanism 31). The body temperature sensor included in the access control apparatus 3 may detect a body temperature of the user U possessing the hearable terminal 1 that has detected the gate detection signal. For example, the access control apparatus 3 may detect a body temperature of the user U by using the body temperature sensor of the access control apparatus 3, by being triggered by the fact that the communication apparatus 14 has received the gate detection signal transmitted by the terminal communication apparatus 35 of the access control apparatus 3. Alternatively, the hearable terminal 1 may transmit the user identification information to the access control apparatus 3, by being triggered by the fact that the communication apparatus 14 has received the gate detection signal transmitted by the terminal communication apparatus 35 of the access control apparatus 3, and the access control apparatus 3 may detect a body temperature of the user U by using the body temperature sensor of the access control apparatus 3, by being triggered by reception of the user identification information transmitted from the hearable terminal 1. Thereafter, the access control apparatus 3 may determine whether or not to permit entry of the user into the management target area MTA, by using the body temperature information related to the body temperature of the user U detected by the body temperature sensor of the access control apparatus 3, and the user identification information received from the hearable terminal 1.

Note that the access control apparatus 3 is not an apparatus worn by a user U. Accordingly, the body temperature sensor included in the access control apparatus 3 may be a sensor capable of detecting a body temperature of a user U from a position away from the user U. The body temperature sensor included in the access control apparatus 3 may be a sensor capable of detecting a body temperature of a user U without contact with the user U. As an example, an infrared body temperature sensor (for example, a body temperature sensor using a thermal camera or a thermographic camera) may be used for the body temperature sensor included in the access control apparatus 3.

In the above description, the access control apparatus 3 determines whether or not to permit entry of a user into the management target area MTA, based on the user identification information. However, the access control apparatus 3 may determine whether or not to permit entry of a user into the management target area MTA, without using the user identification information. In such a case, the hearable terminal 1 does not need to transmit the user identification information to the access control apparatus 3.

In the above description, the access control apparatus 3 notifies the determination result information to the user U, by using voice outputted by the hearable terminal 1. However, the access control apparatus 3 may notify the determination result information to the user U, by using an arbitrary user terminal that is different from the hearable terminal 1 and is possessed by the user U. For example, in a case where the user terminal includes an image output apparatus (that is, a display) capable of outputting information as an image, the access control apparatus 3 may notify the determination result information to the user U by using an image displayed on the user terminal. In such a case, the user U can visually recognize the determination result information. For example, in a case where the user terminal includes a vibratory apparatus capable of vibrating, the access control apparatus 3 may notify the determination result information to the user U by using vibration of the vibratory apparatus. In such a case, the user U can tactually recognize the determination result information. The user terminal may be a user-wearable apparatus (that is, a wearable terminal). Examples of the user-wearable user terminal include at least one of a user terminal like glasses in appearance, a user terminal like a watch in appearance, a user terminal like a pen in appearance, and a user terminal like a ring in appearance. Alternatively, the user terminal does not need to be a user-wearable apparatus. For example, at least one of a smartphone and a tablet terminal possessed by a user may be used for the user terminal. In any case, it is preferable that the user terminal that notifies the determination result information to the user U be an apparatus capable of notifying (in other words, capable of outputting) the determination result information in a notification form (in other words, an output form) in which the user U possessing the user terminal can recognize the determination result information, whereas a user U who does not possess the user terminal cannot recognize the determination result information.

In the above description, for the reason based on which the access control apparatus 3 determines not to permit entry of a user U into the management target area MTA, the access control apparatus 3 adopts the reason that the user U is not authorized to enter the management target area MTA, and the reason that the user U has a disease. However, the access control apparatus 3 may determine not to permit entry of a user U into the management target area MTA, based on another reason. In such a case, since the determination result information indicating the other reason is also notified to the user U by using the hearable terminal 1, it remains the same that the personal information on the user related to the other reason is appropriately protected. In other words, the personal information on the user is appropriately protected also in a case where the access control apparatus 3 determines not to permit entry of the user U into the management target area MTA, based on an arbitrary reason that might defame the user U, might abuse human rights of the user U, might violate privacy of the user, and/or might lead to leakage of the personal information on the user U.

In the above description, the access control apparatus 3 is a separate apparatus from the entry management server 2. However, the entry management server 2 may include at least part of the access control apparatus 3. The access control apparatus 3 may include at least part of the entry management server 2. In other words, the entry management server 2 and the access control apparatus 3 may be at least partially integrated. The entry management system SYS may include a single apparatus that includes at least part of the entry management server 2 and at least part of the access control apparatus 3.

### (5-5-3) Modification of Entry Management Server 2

The history management unit 213 of the entry management server 2 may store (that is, keep), in the storage apparatus 22, the history information related to an archival record of a result of determination as to whether or not to permit entry of a user U into the management target area MTA. At the time, as described above, with consideration given to the fact that the result of determination includes the personal information on the user U, the storage apparatus 22 may store the history information in a form in which the personal information on the user U is protected. For example, the storage apparatus 22 may store the history information in a state where the user identification information and the history information are not associated with each other. In other words, the storage apparatus 22 may store the history information in an anonymous state. For example, in a case where a user U who should be able to enter the management target area MTA according to the entry authorization policy is not permitted to enter the management target area MTA, the storage apparatus 22 does not need to store (that is, does not keep) the history information related to the relevant archival record of the user U. For example, in a case where the entry management system SYS include a surveillance camera capable of monitoring surroundings of the gate mechanism 31, the storage apparatus 22 may store the history information that does not include an archival record of a result of determination, but includes an image captured by the surveillance camera instead. For example, the storage apparatus 22 may delete the stored history information after a fixed time period (for example, one day, a few days, or one week) passes.

Changes can be made as appropriate to the present disclosure within a scope in which no contradiction occurs to the gist or the idea of the present disclosure that can be read from claims and the specification in its entirety, and an entry management system, an entry management apparatus, an entry management method, a computer program, and a recording medium involving such changes are also included in the technical idea of the present disclosure.

### BRIEF DESCRIPTION OF REFERENCE NUMBERS

SYS Entry management system
1 Hearable terminal
11 Body temperature sensor
12 Computation apparatus
121 Communication control unit
122 Notification control unit
15 Speaker
2 Entry management server
3 Access control apparatus
32 Computation apparatus
321 Information acquisition unit
322 Determination unit
323 Notification control unit

What is claimed is:

1. An entry management system for managing entry of a user into a management target area, the entry management system comprising:
a user terminal that is possessed by the user and is capable of notifying information to the user; and
an access control apparatus, wherein
the access control apparatus includes
at least one memory configured to store instructions; and
at least one processor configured to execute the instructions to:
acquire biological information on the user,
determine, based on the biological information, whether or not to permit entry of the user into the management target area, and
in a case where it is determined that entry of the user into the management target area is not permitted, output determination result information related to a result of determination to the user terminal, and
the user terminal is configured to notify the received determination result information to the user.

2. The entry management system according to claim 1, wherein
at least one processor is further configured to execute the instructions to:
acquire the biological information after the user enters the management target area,
determine, based on the biological information, whether or not to permit stay of the user in the management target area after the user enters the management target area, and
in a case where it is determined that stay of the user in the management target area is not permitted, output, to the user terminal, information related to a result of determination that stay of the user in the management target area is not permitted, as the determination result information.

3. The entry management system according to claim 2, wherein
at least one processor is further configured to execute the instructions to, in a case where it is determined that stay of the user in the management target area is not permitted, output, to the user terminal, route information related to an exit route that the user should follow in order to exit the management target area, and
the user terminal is configured to notify the received route information to the user.

4. The entry management system according to claim 3, wherein the exit route includes a route that goes through at least one partial area where the number of other users staying therein is small, as compared to other partial areas, in the management target area.

5. The entry management system according to claim 1, wherein
at least one processor is further configured to execute the instructions to output, to the user terminal, action information related to an action that the user who is denied entry into the management target area is recommended to take, in addition to the determination result information, and
the user terminal is configured to notify the received action information to the user.

6. An access control apparatus for managing entry of a user into a management target area, comprising:
at least one memory configured to store instructions; and
at least one processor configured to execute the instructions to:
acquire biological information on the user;
determine, based on the biological information, whether or not to permit entry of the user into the management target area; and
in a case where it is determined that entry of the user into the management target area is not permitted, output determination result information related to a result of determination to a user terminal that is possessed by the user and is capable of notifying information to the user.

7. An access control method for managing entry of a user into a management target area, comprising:
acquiring biological information on the user;
determining, based on the biological information, whether or not to permit entry of the user into the management target area; and
outputting, in a case where it is determined that entry of the user into the management target area is not permitted, determination result information related to a result of determination to a user terminal that is possessed by the user and is capable of notifying information to the user.

8. A non-transitory recording medium storing a computer program, the computer program controlling a computer in such a manner that the computer executes a control access method for managing entry of a user into a management target area, the access control method including:
acquiring biological information on the user;
determining, based on the biological information, whether or not to permit entry of the user into the management target area; and
outputting, in a case where it is determined that entry of the user into the management target area is not permitted, determination result information related to a result of determination to a user terminal that is possessed by the user and is capable of notifying information to the user.
